(19) United States
(12) Patent Application Publication
(10) Pub. No.: US 2005/0277745 A1
(43) Pub. Date: Dec. 15, 2005

(54) Impact resistant, low shrinkage reinforced molding compositions

(75) Inventors: Robert M. Walrath, Apex, NC (US); William Carroll, Wake Forest, NC (US); Steve Hardebeck, Raleigh, NC (US); Sean Walsh, Carrboro, NC (US)

Correspondence Address: MYERS BIGEL SIBLEY & SAJOVEC, PO BOX 37428, RALEIGH, NC, 27627, US

(73) Assignee: Reichhold, Inc.

(21) Appl. No.: 11/143,204

(22) Filed: Jun. 2, 2005

Related U.S. Application Data
(60) Provisional application No. 60/576,376, filed on Jun. 2, 2004.

(51) Int. Cl. C08L 67/06

(52) U.S. Cl. 525/440

(57) ABSTRACT

The present invention provides a mold composition having improved impact resistance and low shrinkage. The molding composition comprises a urethane chain extended polyester formed by reacting in situ a low molecular weight unsaturated polyester polyol resin and a polyisocyanate intermediate free from ethylenic unsaturation, and a low profile additive.

### CROSS-REFERENCE TO RELATED APPLICATIONS

This application claims the benefit of, and incorporates herein by reference in its entirety, the following United States Provisional Application: U.S. Provisional Application No. 60/576,376, filed Jun. 2, 2004.

### FIELD AND BACKGROUND OF THE INVENTION

The use of unsaturated polyester resins in the molding of glass fiber reinforced or other fiber reinforced products enjoys broad applications in the manufacture of such products as automotive bodies, chairs, heater housings, trays, door “skin” panels, etc. Some of the advantages of such products over metals include lower weight, high strength to weight ratio, resistance to corrosion, and part design flexibility.

In the many applications in which molding compositions have been used, one of the major shortcomings is the overall physical strength of the composition as compared to steel, aluminum, and other materials which compete in the markets. In order to compete, articles made of SMC and BMC usually require increased thicknesses to improve impact strength and physical properties such as Tensile and Flexural strength. Resins can be tailored to improve toughness and thermal properties of the molded articles. The balance between these two properties is primarily dictated by the crosslink density within the resin. The greater the crosslink density, the higher the heat deflection temperature and glass transition temperature but the lower the toughness and impact resistance. Toughness and impact resistance improvements can also be achieved by the addition of flexible moieties, such as ether groups into the polymer backbone, although at the sacrifice of thermal properties. Thus, it is desirable to improve the toughness and impact resistance of the resin system without significantly reducing its thermal properties.

A significant disadvantage of prior art products is that they have rough and undulating surfaces exhibiting a characteristic pattern of the reinforcing fibers. The rough surfaces are attributable, at least in part, to the shrinkage in volume which occurs as the resin polymerizes. While this may not be the only factor contributing to the poor surface smoothness on the moldings, it is thought to be a predominant factor. To overcome the surface roughness and to reduce volume shrinkage, unsaturated polyester technology often employs low profile agents. In order for the low profile agents to perform effectively, high reactivity unsaturated polyester resins are generally required. This high reactivity results in cured resins with very high crosslink densities that are brittle in nature. Toughness in polymer compositions comes about with materials of low crosslink density with high elongations at failure. These tougher materials usually exhibit low glass transition temperatures, low heat distortion temperatures, a low resin modulus and low strength.

The present invention shows that it is possible to utilize high reactivity resins to effect proper low profile behavior yet still have a material with exceptional toughness, impact resistance and a high resin modulus that enhances translation of properties in fiber composites.

Failure from impact is divided into two major fracture modes. The first is a “brittle” type fracture and is most common to fiber reinforced plastics. In a brittle fracture, samples are seen to fail at their maximum load deflection. This is because the energy required for the initiation of a crack is higher than that required for the propagation of the crack and the elastic energy stored in the specimen is great enough to rapidly propagate the crack, causing catastrophic failure. The second mode is a “ductile” fracture and is more commonly seen in metals such as aluminum and steel. In a ductile fracture, the failure occurs after the maximum load deflection. It can then be seen that the elastic energy stored in the specimen is not great enough to cause propagation of the crack, and catastrophic failure is only achieved by adding greater force through the testing device.

Typical molding compounds are brittle in nature and show poor resistance to impact forces. Due to the nature of the high crosslink density found in a molding composition of polyester or vinyl ester, a low speed, point impact causes catastrophic failure of the composition matrix. This makes the system unsuitable for applications such as a pick-up truck bed or bumper beam.

In order to overcome the shortcoming, many in the industry add a higher cost vinyl ester to the system. This is disadvantageous due to the cost associated with the product, and also does not completely solve the problem. Another means to improve the physical toughness of the system is to add rubber-containing compounds. This adds flexibility to the composition, but does not add impact toughness, and also requires the addition of costly emulsifiers needed to stabilize the rubber in a homogeneous solution.

Many applications for which fiber reinforced resinous laminates are used are not critical with respect to surface smoothness, but in certain uses such as automobile surface parts for example, the characteristic rough surface is objectionable. Techniques useful for improving smoothness of glass fiber reinforced moldings which find limited utility include the use of resin-rich gelcoats or veil like glass surfacing mats. In both instances a resin rich surfaces is obtained which serves to submerge the reinforced glass strands and make them less noticeable. These techniques add processing steps and or cost to the production of the articles.

Often it is desirable to paint moldings used in automotive applications, for example, to achieve a smooth, metal-like, high-gloss appearance. In order to accomplish this it is common practice to resort to time and man power consuming dry sanding operations to improve the surface smoothness before applying the finish coating.

The present invention avoids the applications of resin-rich gelcoats or expensive and time consuming sanding or other mechanical pre-finish operations. By utilizing the compositions, as herein after more fully described, articles are produced which have a high degree of surface smoothness, sufficient in most instances to allow direct application of a protective and decorative coating such as paint, lacquer, etc., and which produce faithfully and with high fidelity the mold design with which they may have made.

Prior art efforts to improve the toughness of molding compositions include the following. U.S. Pat. No. 5,116,917 proposes a thermosettable vinyl ester resinous composition and low profile additive. The improvement comprises the low profile additive comprising a non-gelling, saturated polyester formed from dibasic acid and an ethylene oxide/propylene oxide polyether polyol having an EO/PO molar ratio ranging from about 0.1 to 0.9. The polyester has an acid value of greater than about 10 and preferably has a molecular weight of greater than about 6,000. The EO/PO polyether polyol can be built on a combination of diol, triol or other compounds with active hydrogen groups, so long as the LPA product does not gel.

U.S. Pat. No. 5,491,184 describes compatible saturated polyester polymer blocks having terminal alkylene maleate end blocks formulated into an unsaturated polyester or vinyl ester resin composition. These saturated polyester blocks may also have small amounts of aromatic diacids in their polymer backbone. The incorporation of these saturated polyesters, which have a lower T_{g} than the unsaturated polyesters, gives the composition higher strain to failure or crack values while maintaining high modulus, good molded part surface quality, and low in-mold shrinkage. These compositions are generally used in highly filled, fiber reinforced molded parts.

U.S. Pat. No. 5,342,554 proposes vinyl-terminated polyesters and vinyl-terminated aliphatic polycarbonates free from internal unsaturation reactive in free radical crosslinking. These vinyl-terminated polymers achieve improved flexibility and elongation to failure without significant decreases-in modulus and with good molded surface quality not found in prior art modifications of thermoset polyesters. These vinyl-terminated polymers are generally soluble in the unsaturated polyester styrene solution, and these three components generally form a one phase blend upon cure.

U.S. patent application Ser. No. 20030100651 proposes a molding compound containing a reinforcing fiber, a non-fibrous filler, and an unsaturated polyester resin. The unsaturated polyester resin contains an unsaturated monomer as well as a polyester polymer. The polymer is a unsaturated polyester made from a hydroxyl component and a carboxylic component. The hydroxyl component contains both a monomeric diol or triol, and a polymeric polyol. The polymeric polyol is a hydroxyl-terminated polymer such as polyether or polyester diols or triols. The carboxylic component can be provided by an unsaturated carboxylic diacid, an unsaturated carboxylic anhydride, an unsaturated carboxylic diester or mixtures thereof.

### SUMMARY OF THE INVENTION

The present invention provides a mold composition having improved impact resistance and low shrinkage. The molding composition comprises a urethane chain extended polyester formed by reacting in situ a low molecular weight unsaturated polyester polyol resin and a polyisocyanate intermediate free from ethylenic unsaturation and a low profile additive.

### DETAILED DESCRIPTION OF THE INVENTION

As summarized above, the molding composition of the present invention comprises a urethane chain extended polyester formed by reacting in situ a low molecular weight unsaturated polyester polyol resin and a polyisocyanate intermediate free from ethylenic unsaturation, a low profile additive, optionally filler and/or fiber reinforcement. A low molecular weight unsaturated polyester resin may be formed by conventional methods. Typically, the resin is formed from the reaction between a polyfunctional organic acid or anhydride and a polyhydric alcohol under conditions known in the art. The polyfunctional organic acid or anhydride which may be employed are any of the numerous and known compounds. Suitable polyfunctional acids or anhydrides thereof include, but are not limited to, maleic acid, fumaric acid, citraconic acid, itaconic acid, glutaconic acid, phthalic acid, isophthalic acid, terephthalic acid, tetrahydrophthalic anhydride, cyclohexane dicarboxylic acid, succinic anhydride, adipic acid, sebacic acid, azelaic acid, malonic acid, alkenyl succinic acids such as n-dodecenyl succinic acid, dodecylsuccinic acid, octadecenyl succinic acid, and anhydrides thereof. Lower alkyl esters of any of the above may also be employed. Mixtures of any of the above are suitable, without limitation intended by this.

Additionally, polybasic acids or anhydrides thereof have not less than three carboxylic acid groups may be employed. Such compounds include 1,2,4-benzenetricarboxylic acid, 1,3,5-benzene tricarboxylic acid, 1,2,4-cyclohexane tricarboxylic acid, 2,5,7-naphthalene tricarboxylic acid, 1,2,4-naphthalene tricarboxylic acid, 1,3,4-butane tricarboxylic acid, 1,2,5-hexane tricarboxylic acid, 1,3-dicarboxyl-2-methyl-2-carboxymethylpropane, tetra(carboxymethyl)methane, 1,2,7,8-octane tetracarboxylic acid, and mixtures thereof.

Suitable polyhydric alcohols which may be used in forming the unsaturated polyester resins include, but are not limited to, ethylene glycol, diethylene glycol, triethylene glycol, propylene glycol, dipropylene glycol, 1,3-butanediol, 1,4-butanediol, 1,3-hexanediol, neopentyl glycol, 2-methyl-1,3-pentanediol, 1,3-butylene glycol, 1,6-hexanediol, hydrogeneated bisphenol “A”, cyclohexane dimethanol, 1,4-cyclohexanol, ethylene oxide adducts of bisphenols, propylene oxide adducts of bisphenols, sorbitol, 1,2,3,6-hexanetetrol, 1,4-sorbitan, pentaerythritol, dipentaerythritol, tripentaerythritol, 1,6-hexanediol dipentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene. Mixtures of any of the above alcohols may be used.

The low molecular weight polyester is used in amounts ranging from 10 to 90 parts by weight of the total resin mixture, and preferably in amounts ranging from 20 to 50 parts by weight. The molecular weight of the polymerizable unsaturated polyester may vary over considerable a range, but ordinarily those polyesters useful in the practice of the present invention have a molecular weight ranging from about 500 to 5000, and more preferably, from about 700 to about 2000. The polyester employed must have a high reactivity for proper low profile activity. This invention employs an unsaturated polyester resin with 5 to 7.5 double bonds per kilogram of resin. The preferred range is 6 to 7 double bonds per kilogram of resin. In order to react with the isocyanate moieties, the polyester should have a hydroxyl number between 50 and 200 mg KOH per gram of resin, with a preferred range of 100 to 130.

Optionally, a higher molecular weight unsaturated polyester can also be added. Typically, the molecular weight is from about 5,000 to about 10,000. The higher molecular weight polyester can raise unsaturation content, reduce cost, and improve mechanical properties, e.g., toughening.

Polyisocyanates intermediates employed in the present invention are aromatic, aliphatic and cycloaliphatic polyisocyanates having 2 or more isocyanate groups per molecule and having an isocyanate equivalent weight of less than 300. Preferably the isocyanates are essentially free from ethylenic unsaturation and have no other substituents capable of reacting with the unsaturated polyester polyol resin. Polyfunctional isocyanates which are used in the above reactions are well known to the skilled artisan. For the purposes of the invention, diisocyantes include aliphatic, cycloaliphatic, araliphatic, aromatic and heterocyclic diisocyantes of the type described, for example, by W. Siefken in Justus Liebigs Annalen der Chemie, 562, pages 75 to 136, (1949) for example, those corresponding to the following formula:
OCN—R—(NCO)ₙ
wherein n is equal to 1 to 3 and R represents a difunctional aliphatic, cycloaliphatic, aromatic, or araliphatic radical having from about 4 to 25 carbon atoms, preferably 4 to 15 carbon atoms, and free of any group which can react with isocyanate groups. Exemplary diisocyantes include, but are not limited to, toluene diisocyanate; 1,4-tetramethylene diisocyanate; 1,4-hexamethylene diisocyanate; 1,6-hexamethylene diisocyanate; 1,12-dodecane diisocyante; cyclobutane-1,3-diisocyanate; cyclohexane-1,3-diisocyanate; cyclohexane-1,4-diisocyanate; 1-isocyanato-3,3,5-trimethyl-5-isocyanatomethyl cyclohexane; 2,4-hexahydrotolylene diisocyanate; 2,6-hexahydrotolylene diisocyanate; 2,6-hexahydro-1,3-phenylene diisocyanate; 2,6-hexahydro-1,4-phenylene diisocyanate; per-hydro-2,4′-diphenyl methane diisocyanate; per-hydro-4,4′-diphenyl methane diisocyanate; 1,3-phenylene diisocyanate; 1,4-phenylene diisocyanate; 2,4-tolylene diisocyanate, 2,6-toluene diisocyanates; diphenyl methane-2,4′-diisocyanate; diphenyl methane-4,4′-diisocyanate; naphthalene-1,5-diisocyanate; 1,3-xylylene diisocyanate; 1,4-xylylene diisocyanate; 4,4′-methylene-bis(cyclohexyl isocyanate); 4,4′-isopropyl-bis-(cyclohexyl isocyanate); 1,4-cyclohexyl diisocyanate; 3-isocyanatomethyl-3,5,5-trimethylcyclohexyl isocyanate (IPDI); 1-methyoxy-2,4-phenylene diisocyanate; 1-chloropyhenyl-2,4-diisocyante; p-(1-isocyanatoethyl)-phenyl isocyanate; m-(3-isocyanatobutyl)-phenyl isocyanate; and 4-(2-isocyanate-cyclohexyl-methyl)-phenyl isocyanate. Mixtures of any of the above may be employed. A diisocyante may be employed which contains other functional groups such as amino functionality.

The preferred polyfunctional isocyanate intermediate free from ethylenic unsaturation consists of a polyfunctional additive prepared by the one step-addition reaction between one equivalent weight of a diol or triol of molecular weight from 60 to 3000 and an excess of the polyfunctional isocyanate. The polyfunctional isocyanate excess is added in a quantity sufficient to allow unreacted polyfunctional isocyanate to remain free in the mixture after the reaction with the diol or triol in an amount of 0.01 to 50% by weight of the total mixture and most preferable in an amount of 1 to 30% by weight of the mixture. In the reaction involving the diol or triol with the polyfunctional isocyanate, it is preferred to employ a catalyst. A number of catalysts know to the skill artisan may be used for this purpose. Suitable catalysts are described in U.S. Pat. Nos. 5,925,409 and 4,857,579, the disclosures of which are hereby incorporated by reference in their entireties.

Examples of the polyhydric alcohol having at least 2 hydroxyl groups in the molecule and a hydroxyl value of 35 to 1,100 mgKOH/g include ethylene glycol, propylene glycol, diethylene glycol, triethylene glycol, 1,5-pentane diol, 1,6-hexane diol, polyethylene glycol and polypropylene having a molecular weight of 200 to 3000, polytetramethylene glycol having a molecular weight of 200 to 3000, etc.

In the present invention, any radically polymerizable alkene can serve as a first or second reactive moiety or monomer for polymerization. However, co-monomers that correspond to the following formula are especially suitable for polymerization in accordance with the invention: 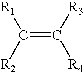
where R₁ and R₂ are independently selected from the group consisting of H, halogen, CN, straight or branched alkyl of from 1 to 20 carbon atoms, preferably 1 to 6, and more preferably 1 to 4 carbon atoms, which can be substituted with 1 to (2n+1) halogen atoms where n is the number of carbon atoms of the alkyl group (for example CF₃), α, β-unsubstituted straight or branched alkenyl or alkynyl groups with 2 to 10 carbon atoms, preferably 2 to 6 and specially preferably 2 to 4 carbon atoms which can be substituted with 1 to (2n−1) halogen atoms where n is the number of carbon atoms of the alkyl group, α, β-unsaturated straight or branched of 2 to 6 carbon atoms (preferably vinyl) substituted (preferably at the α-position) with a halogen (preferably chlorine), C₃-C₈ cycloalkyl, heterocyclyl, C(═Y)R₅, C(═Y)NR₆R₇, YC (═Y)R₅, SOR₅, SO₂R₅, OSO₂R₅, NR₈SO₂R₅, PR₅₂, P(═Y)R₅², YPR₅², YP(═Y) R₅², NR₈², which can be quaternized with an additional R₈, aryl, or heterocyclyl group, where Y may be NR₈, S or O, preferable O; R₅ is alkyl of from 1 to 20 carbon atoms, an alkylthio group with 1 to 20 carbon atoms, OR₁₅ (R₁₅ is hydrogen or an alkyl metal), alkoxy of from 1 to 20 carbon atoms, aryloxy or heterocyclyloxy; R₆ and R₇ are independently H or alkyl of from 1 to 20 carbon atoms, or R₆ and R₇ may be joined together to form an alkylene group of from 2 to 7 carbon atoms, preferably 2 to 5 carbon atoms, where they form a 3- to 8-member ring, preferably 3 to 6 member ring, and R₈ is H, straight or branched C₁-C₂₀ alkyl or aryl; and R₃ and R₄ are independently selected from the group consisting of H, halogen (preferably chlorine or fluorine), C₁-C₆ alkyl or COOR₉, where R₉ is H, an alkyl metal, or a C₁-C₄₀ alkyl group; or R₁ and R₃ can together form a group of the formula (CH₂)ₙ; which can be substituted with 1 to 2n halogen atoms or a group of the formula C(═O)—Y—C(═O), where n is from 2 to 6, preferably 3 to 4, and Y is defined as before; and where at least two of R₁, R₂, R₃ and R₄ are H or halogen.

Furthermore in the present application, “aryl” refers to phenyl, naphthyl, phenanthryl, anthracenyl, phenalenyl, tripehnylenyl, fluoranthrenyl, pyrenyl, pentacenyl, chrycenyl, naphthacenyl, hexaphenyl, picenyl and perynelenyl (preferably phenyl and naphthyl), in which each hydrogen atom may be replaced with alkyl of from 1 to 20 carbon atoms (preferably from 1 to 6 carbon atoms and more preferably methyl) alkyl of from 1 to 20 carbon atoms (preferably from 1 to 6 carbon atoms and more preferably methyl) in which each of the hydrogen atoms is independently replaced by a halide (preferably a fluoride or a chloride), alkenyl of from 2 to 20 carbon atoms, alkynyl of from 1 to 20 carbon atoms, alkoxy from 1 to 6 carbon atoms, alkylthio of from 1 to 6 carbon atoms, C₃-C₈ cycloalkyl, phenyl, halogen, NH₂, C₁-C₆-alkylamino, C₁-C₆ dialkylamino, and phenyl which may be substituted with the from 1 to 5 halogen atoms and/or C₁-C₄ alkyl groups. (This definition of “aryl” also applies to the aryl groups in “aryloxy” and “aralkyl”). Thus phenyl may be substituted from 1 to 5 times and naphthyl may be substituted from 1 to 7 times (preferably, any aryl group, if substituted, is substituted from 1 to 3 times) with one of the above substituents. More preferably, “aryl” refers to phenyl, naphthyl, phenyl substituted from 1 to 5 times with fluorine or chlorine, and phenyl substituted from 1 to 3 times with a substituent selected from the group selected from the group consisting of alkyl of from 1 to 6 carbon atoms, alkoxy of from 1 to 4 carbon atoms and phenyl. Most preferably, “aryl” refers to phenyl, tolyl and methoxyphenyl. Preferred substituents include amines, substituted phosphorus, sylyl, siloxy, epoxy, isocyanate and hydroxyl.

In the context of the present invention, “heterocyclyl” refers to pyrydyl furyl, pyrrolyl, furyl, pyrrolyl, thienyl, imidazolyl, pyrazolyl, pyrazinyl, pyridiminyl, pyridazinyl, pyranyl, indonyl, isoindonyl, indazolyl, benzofuryl, isobenzofuryl, benzothienyl, isobenzothienyl, chromenyl, xanthenyl, purinyl, pteridinyl, quinolyl, isoquinolyl, phthalazinyl, quinazolinyl, quinoxalinyl, naphthyridinyl, phenoxathiinyl, carbazolyl, cinnolinyl, phenanthridinyl, acridinyl, 1,10-phenanthrolinyl, phenazinyl, phenoxazinyl, phenothiazinyl, oxazolyl, thiazolyl, isoxaloyl, and hydrogenated forms thereof known to those in the art. Preferred hetrerocyclyl groups include imidazolyl, pyrazolyl, pyrazinyl, pyridyl, furyl, pyrrolyl, thienyl, pyrimidinyl, pyridazinyl, pyranyl, and indolyl.

Classes of other reactive unsaturated moieties or monomers also include, but are not limited to, (meth)acrylates, vinyl aromatic monomers, vinyl halides and vinyl esters of carboxylic acids. As is used herein and in the claims, by “(meth)acrylate” and the like terms is meant both (meth)acrylates and acrylates. Examples include but are not limited to oxyranyl (meth)acrylates like 2,3-epoxybutyl (meth)acrylate, 3,4-epoxybutyl (meth)acrylate, 10,11 epoxyundecyl (meth)acrylate, 2,3-epoxycyclohexyl (meth)acrylate, glycidyl (meth)acrylate, hydroxyalkyl (meth) acrylates like 3-hydroxypropyl (meth)acrylate, 2,5-dimethyl-1,6-hexanediol (meth)acrylate, 1,10-decanediol (meth)acrylate, aminoalkyl (meth)acrylates like N-(3-dimethylaminopentyl (meth)acrylate, 3-dibutylaminohexadecyl (meth)acrylate; nitriles of (meth)acrylic acid and other nitrogen containing (meth)acrylates like N-((meth)acryloyloxyethyl)diisobutylketimine, N-((meth)acryloylethoxyethyl)dihexadecylketimine, (meth)acryloylamidoacetonitrile, 2-(meth)acryloxyethylmethylcyanamide, cyanoethyl (meth)acrylate, aryl (meth)acrylates like benzyl (meth)acrylate or phenyl (meth)acrylate, where the acryl residue in each case can be unsubstituted or substituted up to four times; carbonyl-containing (meth)acrylates like 2-carboxyethyl (meth)acrylate, carboxymethyl (meth)acrylate, oxazolidinylethyl (meth)acrylate, N-((meth)acryloyloxy) formamide, acetonyl (meth)acrylate, N-(meth)acryloylmorpholine, N-(meth)acryloyl-2-pyrrolidinone, N-(2-(meth)acryloxyoxyethyl)-2-pyrrolidinone, N-(3-(meth)acryloyloxypropyl)-2-pyrrolidinone, N-(2-(meth)acryloyloxypentadecenyl)-2-pyrrolidinone, N-(3-(meth)acryloyloxyheptadecenyl)-2-pyrrolidinone; (meth)acrylates of ether alcohols like tetrahydrofurfuryl (meth)acrylate, vinyloxyethoxyethyl (meth)acrylate, methoxyethoxyethyl (meth)acrylate, 1-butoxypropyl (meth)acrylate, 1-methyl-(2-vinyloxy)ethyl (meth)acrylate, cyclohexyloxymethyl (meth)acrylate, methoxymethoxyethyl (meth)acrylate, bezyloxymethyl (meth)acrylate, furfuryl (meth)acrylate, 2-butoxyethyl (meth)acrylate, 2-ethoxyethoxymethyl (meth)acrylate, 2-ethoxyethyl (meth)acrylate, allyloxymethyl (meth)acrylate, 1-ethoxybutyl (meth)acrylate, ethoxymethyl(meth)acrylate; (meth)acrylates of halogenated alcohols, like 2,3-dibromopropyl (meth)acrylate, 4-bromophenyl (meth)acrylate, 1,3-dichloro-2-propyl (meth)acrylate, 2-bromoethyl (meth)acrylate, 2-iodoethyl (meth)acrylate, chloromethyl (meth)acrylate, 2-isocyanatoethyl methacrylate, vinyl isocyanate, 2-acetoacetoxyethyl methacrylate; phosphorus-, boron, and/or silicon-containing (meth)acrylates like 2-(dimethylphosphato)propyl (meth)acrylate, 2-(ethylphosphito)propyl (meth)acrylate, dimethylphosphinoethyl (meth)acrylate, dimethylphosphinomethyl (meth)acrylate, dimethylphosphonoethyl (meth)acrylate, dimethyl(meth)acryloyl phosphonate, dipropyl(meth)acryloyl phosphate, 2-(dibutylphosphono)ethyl methacrylate, 2,3-butelene(meth)acryloylethyl borate, methyldiethoxy(meth)acryloylethoxysilane, diethylphosphatoethyl (meth)acrylate; sulfur-containing (meth)acrylates like ethylsulfinylethyl (meth)acrylate, 4-thiocyanatobutyl (meth)acrylate, ethylsulfonylethyl (meth)acrylate, thiocyanathomethyl (meth)acrylate, methylsulfonylmethyl (meth)acrylate, bis((meth)acryloyloxyethyl) sulfide.

Thermoplastic polymeric materials (low profile agents) which reduce shrinkage during molding can also be included in the composition of the invention. These thermoplastic materials can be used to produce molded articles having surfaces of improve smoothness. The thermoplastic resin is added into the unsaturated polyester composition according to the invention in order to suppress shrinkage at the time of curing. The thermoplastic resin is provided in a liquid form and is prepared in such a manner that 30 to 45% by weight of the thermoplastic resin is dissolved in 55 to 70% by weight of polymerizable monomer having some polymerizable double bond in one molecule. Examples of the thermoplastic resin may include styrene-base polymers, polyethylene, polyvinyl acetate base polymer, polyvinyl chloride polymers, polyethyl methacrylate, polymethyl methacrylate or copolymers, ABS copolymers, hydrogenated ABS, polycaprolactone, polyurethanes, butadiene styrene copolymer, and saturated polyester resins. Additional examples of thermoplastics are copolymers of: vinyl chloride and vinyl acetate; vinyl acetate and acrylic acid or methacrylic acid; styrene and acrylonitrile; styrene acrylic acid and allyl acrylates or methacrylates; methyl methacrylate and alkyl ester of acrylic acid; methyl methacrylate and styrene; methyl methacrylate and acrylamide. In the resin composition according to the invention, 5 to 50% by weight of the liquid thermoplastic resin is mixed, preferably 10 to 30% by weight of the liquid thermoplastic resin is mixed.

Low profile agents present some problems remaining compatible with almost all types of thermosetting resin systems. The incompatibility between the polymeric materials introduces processing difficulties due to the poor homogeneity between the resins. Problems encountered due to phase separation in the resin mixture include, scumming, poor color uniformity, low surface smoothness and low gloss. It is therefore important to incorporate components that the will help on stabilizing the resin mixture to obtain homogeneous systems that will not separate after their preparation. For this purpose, a variety of stabilizers can be used in the present invention which includes block copolymers from polystyrene-polyethylene oxide such as those described in U.S. Pat. Nos. 3,836,600 and 3,947,422, the disclosures of which are incorporated by reference in their entirety. Also useful are block copolymer stabilizers formed from styrene and a half ester of maleic anhydride containing polyethylene oxide such as described in U.S. Pat. No. 3,947,422, the disclosure of which is incorporated by reference in its entirety. Another useful stabilizer is a saturated polyester prepared from hexanediol, adipic acid and polyethylene oxide available from BYK Chemie under code number W-972. Other type of stabilizers may also include addition-type polymers prepared from vinyl acetate block copolymer and a saturated polyester as described in Japanese Unexamined Patent application No. Hei 3-174424. The amount of compatabilizer is from about 0.1 to 2 parts by weight.

Ethylenically unsaturated monomers that may be included as a diluent, reactant, co-reactant or may be post added once the polymerization of the desired polymer and/or oligomer was completed, and may include those such as, for example, styrene and styrene derivatives such as α-methyl styrene, p-methyl styrene, divinyl benzene, divinyl toluene, ethyl styrene, vinyl toluene, tert-butyl styrene, monochloro styrenes, dichloro styrenes, vinyl benzyl chloride, fluorostyrenes, tribromostyrenes, tetrabromostyrenes, and alkoxystyrenes (e.g., paramethoxy styrene). Other monomers which may be used include, 2-vinyl pyridine, 6-vinyl pyridine, 2-vinyl pyrrole, 2-vinyl pyrrole, 5-vinyl pyrrole, 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxozole, 3-vinyl isothiazole, 2-vinyl pyrimidine, 4-vinyl pyrimidine, 6-vinyl pyrimidine, any vinyl pyrazine. Classes of other vinyl monomers also include, but are not limited to, (meth)acrylates, vinyl aromatic monomers, vinyl halides and vinyl esters of carboxylic acids. As is used herein and in the claims, by “(meth)acrylate and the like terms is meant both (meth)acrylates and acrylates. Examples include but are not limited to oxyranyl (meth)acrylates like 2,3-epoxybutyl (meth)acrylate, 3,4-epoxybutyl (meth)acrylate, 10,11 epoxyundecyl (meth)acrylate, 2,3-epoxycyclohexyl (meth)acrylate, glycidyl (meth)acrylate, hydroxyalkyl (meth) acrylates like 3-hydroxypropyl (meth)acrylate, 2,5-dimethyl-1,6-hexanediol (meth)acrylate, 1,10-decanediol (meth)acrylate, aminoalkyl (meth)acrylates like N-(3-dimethylaminopentyl (meth)acrylate, 3-dibutylaminohexadecyl (meth)acrylate; nitriles of (meth)acrylic acid and other nitrogen containing (meth)acrylates like N-((meth)acryloyloxyethyl)diisobutylketimine, N-((meth)acryloylethoxyethyl)-dihexadecylketimine, (meth)acryloylamidoacetonitrile, 2-(meth)acryloxyethylmethylcyanamide, cyanoethyl (meth)acrylate, aryl (meth)acrylates like benzyl (meth)acrylate or phenyl (meth)acrylate, where the acryl residue in each case can be unsubstituted or substituted up to four times; carbonyl-containing (meth)acrylates like 2-carboxyethyl (meth)acrylate, carboxymethyl (meth)acrylate, oxazolidinylethyl (meth)acrylate, N-((meth)acryloyloxy) formamide, acetonyl (meth)acrylate, N-(meth)acryloylmorpholine, N-(meth)acryloyl-2-pyrrolidinone, N-(2-(meth)acryloxyoxyethyl)-2-pyrrolidinone, N-(3-(meth)acryloyloxypropyl)-2-pyrrolidinone, N-(2-(meth)acryloyloxypentadecenyl)-2-pyrrolidinone, N-(3-(meth)acryloyloxyheptadecenyl)-2-pyrrolidinone; (meth)acrylates of ether alcohols like tetrahydrofurfuryl (meth)acrylate, vinyloxyethoxyethyl (meth)acrylate, methoxyethoxyethyl (meth)acrylate, 1-butoxypropyl (meth)acrylate, 1-methyl-(2-vinyloxy)ethyl (meth)acrylate, cyclohexyloxymethyl (meth)acrylate, methoxymethoxyethyl (meth)acrylate, bezyloxymethyl (meth)acrylate, furfuryl (meth)acrylate, 2-butoxyethyl (meth)acrylate, 2-ethoxyethoxymethyl (meth)acrylate, 2-ethoxyethyl (meth)acrylate, allyloxymethyl (meth)acrylate, 1-ethoxybutyl (meth)acrylate, ethoxymethyl(meth)acrylate; (meth)acrylates of halogenated alcohols, like 2,3-dibromopropyl (meth)acrylate, 4-bromophenyl (meth)acrylate, 1,3-dichloro-2-propyl (meth)acrylate, 2-bromoethyl (meth)acrylate, 2-iodoethyl (meth)acrylate, chloromethyl (meth)acrylate; various (meth)acrylates containing polyethoxylated or polypropoxylated hydroxyl terminated or polyethers derived from alcohols, phenols (including alkyl phenols) and carboxylic acids can be used; phosphorus-, boron, and/or silicon-containing (meth)acrylates like 2-(dimethylphosphato)propyl (meth)acrylate, 2-(ethylphosphito)propyl (meth)acrylate, dimethylphosphinoethyl (meth)acrylate, dimethylphosphinomethyl (meth)acrylate, dimethylphosphonoethyl (meth)acrylate, dimethyl(meth)acryloyl phosphonate, dipropyl(meth)acryloyl phosphate, 2-(dibutylphosphono)ethyl methacrylate, 2,3-butelene(meth)acryloylethyl borate, methyldiethoxy(meth)acryloylethoxysilane, diethylphosphatoethyl (meth)acrylate; sulfur-containing (meth)acrylates like ethylsulfinylethyl (meth)acrylate, 4-thiocyanatobutyl (meth)acrylate, ethylsulfonylethyl (meth)acrylate, thiocyanathomethyl (meth)acrylate, methylsulfonylmethyl (meth)acrylate, bis((meth)acryloyloxyethyl) sulfide; suitable polyfunctional acrylate may be used in the resin composition, including those described, for example, in U.S. Pat. No. 4,916,023 to Kawabata et al., the disclosure of which is incorporated by reference herein in its entirety. Such compounds include, but are not limited to, ethylene glycol (EG) dimethacrylate, butanediol dimethacrylate, and the like. Polyfunctional acrylates may be used in the resin composition, including those described, for example, in U.S. Pat. No. 5,925,409 to Nava, the disclosure of which is incorporated by reference herein in its entirety. Such compounds include, but are not limited to, ethylene glycol (EG) dimethacrylate, butanediol dimethacrylate, and the like. The polyfunctional acrylate which may be used in the present invention can be represented by the general formula: 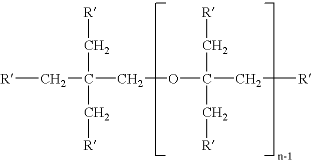
wherein at least four of the represented R′ groups present are (meth)acryloxy groups, with the remainder of the R′ groups being an organic group except (meth)acryloxy groups, and n is an integer from 1 to 5. Examples of polyfunctional acrylates include ethoxylated trimethyolpropane triacrylate, trimethyolpropane tri(meth)acrylate, trimethyolpropane triacrylate, trimethylolmethane tetra(meth)acrylate, pentaerythritol tetra(meth)acrylate, dipentaerythritol tetra(meth) acrylate, dipentaerythritol penta(meth)acrylate, and dipentaerythritol hexa(meth)acrylate; heterocyclic (meth)acrylates like 2-(1-imidazolyl)ethyl (meth)acrylate, 2-(4-morpholyl)ethyl (meth)acrylate and 1-(2-(meth)acryloyloxyethyl)-2-pyrrolidinone; vinylhalides such as vinyl chloride, vinyl fluoride, vinylidene chloride and vinylidene fluoride; vinyl esters like vinyl acetate, vinyl butyrate, vinyl 3,4-dimethoxybenzoate, vinyl benzoate and isoprenyl esters; crotonic acid, itaconic acid or anhydride, maleic acid and maleic acid derivatives such as mono and diesters of maleic acid, maleic anhydride, methyl maleic anhydride, methylmaleimide; fumaric and fumaric acid derivatives such as mono and diesters of fumaric acid.

As used herein and in the claims, by “olefin” and the like terms is meant unsaturated aliphatic hydrocarbons having one or more double bonds, obtained by cracking petroleum fractions. Specific examples of olefins may include, but are not limited to, propylene, 1-butene, 1.3-butadiene, isobutylene and di-isobutylene.

As used herein and in the claims, by “(meth)allylic monomer(s)” is meant monomers containing substituted and/or unsubstituted allylic functionality, i.e., one or more radicals represented by the following general formula:
H₂C═C(Q)-CH₂—
wherein Q is a hydrogen, halogen or a C₁ to C₄ alkyl group. Most commonly, Q is a hydrogen or a methyl group, but are not limited to; (meth)allyl alcohol; (meth)allyl ethers, such as methyl (meth)allyl ether, (meth)allyl esters of carboxylic acids, such as (meth)allyl acetate, (meth)allyl benzoate, (meth)allyl n-butyrate, (meth)allyl esters of VERSATIC acid, and the like. These components can be added to a reaction mixture at the same time or sequentially.

A large number of mixtures, which all contain monomers that are to be polymerized, can be used to obtain the desired compositions of the thermosetting mixture. The molding composition can further include one or more additives including fiber reinforcement, antioxidants, solvents, polymerization inhibitors, chain transfer agents, fillers, thickening agents, flow agents, polymerization accelerators, lubricants, air release agents, wetting agents, UV stabilizers, compatibilizers, fire retardants, urethane reaction catalysts, moisture scavengers, and shrink-reducing additives.

Optionally a thickening agent is added to the molding compound in the range of 0.05 to 10%, preferably in the range of 0.2 to 5% by weight of the chemical thickener, based on the weight of the molding compound. The thickening agent is added to facilitate increasing the viscosity of the compounding mixture. Examples include CaO, Ca(OH)₂, MgO or Mg(OH)₂. Any suitable chemical thickener contemplated by one skill in the molding compound art may be used.

The addition of fiber(s) provide a means for strengthening or stiffening the polymerized molding composition. The types often used are: inorganic crystals or polymers, e.g., fibrous glass, quartz fibers, silica fibers, fibrous ceramics, e.g., alumina-silica (refractory ceramic fibers); boron fibers, silicon carbide, silicon carbide whiskers or monofilament, metal oxide fibers, including alumina-boric-silica, alumina-chromia-silica, zirconia-silica, and others; organic polymer fibers, e.g., fibrous carbon, fibrous graphite, acetates, acrylics (including acrylonitrile), aliphatic polyamides (e.g. nylon), aromatic polyamides, olefins (e.g., polypropylenes, polyesters, ultrahigh molecular weight polyethylenes), polyurethanes (e.g., Spandex), alpha-cellulose, cellulose, regenerated cellulose (e.g., rayon), jutes, sisal, vinyl chlorides , vinylidenes, flax, and thermoplastic fibers; metal fibers, e.g., aluminum, boron, bronze, chromium, nickel, stainless steel, titanium or their alloys; and “whiskers”, single, inorganic crystals.

Suitable filler(s) non-fibrous are inert, particulate additives being essentially a means of reducing the cost of the final product while often reducing some of the physical properties of the polymerized molding compound. Fillers used in the invention include calcium carbonate of various form and origins, silica of various forms and origins, silicates, silicon dioxides of various forms and origins, clays of various forms and origins, feldspar, kaolin, flax, zirconia, calcium sulfates, micas, talcs, wood in various forms, glass (milled, platelets, spheres, micro-balloons), plastics (milled, platelets, spheres, micro-balloons), recycled polymer composite particles, metals in various forms, metallic oxides or hydroxides (except those that alter shelf life or viscosity), metal hydrides or metal hydrates, carbon particles or granules, alumina, alumina powder, aramids, bronze, carbon black, carbon fiber, cellulose, alpha cellulose, coal (powder), cotton, fibrous glass, graphite, jute, molybdenum, nylon, orlon, rayon, silica amorphous, sisal fibers, fluorocarbons and wood flour.

The fibrous materials may be incorporated into the resin in accordance with techniques which are known in the art. Fillers may include but are not limited to calcium carbonate, calcium sulfate, talc, aluminum oxide, aluminum hydroxide, silica gel, barite, carbon powder, etc. Preferably, the filler is added in amount between 0 to 80% by weight and more preferably in an amount of 20 to 60% by weight based on the resin composition.

Polymerization inhibitors may also be included in the polymerization mixture such as phenol, 2,6-di-tert-butyl-4-methyl phenol, hydroquinone (HQ), tolyl-hydroquinone (THQ), bisphenol “A” (BPA), naphthoquinone (NQ), p-benzoquinone (p-BQ), butylated hydroxy toluene (BHT), Hydroquinone monomethyl ether (HQMME), 4-ethoxyphenol, 4-propoxyphenol, and propyl isomers thereof, monotertiary butyl hydroquinone (MTBHQ), ditertiary Butyl hydroquinone (DTBHQ), tertiary butyl catechol (TBC), 1,2-dihydroxybenzene, 2,5-dichlorohydroquinone, 2-acetylhydroquinone, 1,4-dimercaptobenzene, 4-aminophenol, 2,3,5-trimethylhydroquinone, 2-aminophenol, 2-N,N,-dimethylaminophenol, catechol, 2,3-dihrydroxyacetrophenone, pyrogallol, 2-methylthiophenol. Other substituted and un-substituted phenols and mixtures of the above may be used. Preferably 0.001 to 0.200 parts by weight is added.

Other polymerization inhibitors include stable hinder nitroxyl compounds having the structural formula: 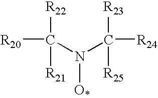
where R₂₀, R₂₁, R₂₅ and R₂₄ are the same or different straight chain or branch substituted or unsubstituted alkyl groups of a chain length. R₂₃ and R₂₄ are independently selected from the group consisting of halogen, cyano, COOR₂₀, —S—COR₂₀, —OCOR₂₀, amido, —S—C₆H₅, carbonyl, alkenyl, or alkyl of 1 to 15 carbon atoms, or may be part of a cyclic structure which may be fused with it another saturated or aromatic ring.

In a particular preferred embodiment, the stable hindered nitroxyl compound has the structural formula: 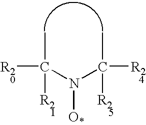
where R₂₀ and R₂₄ are independently selected from the group consisting of hydrogen, alkyl, and heteroatom-substituted alkyl and R₂₁ and R₂₅, are independently selected from the group consisting of alkyl heteroatom-substituted alkyl, and the 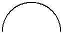
portion represents the atoms necessary to form a five-, six-, or seven member ring heterocyclic ring.

Accordingly one of the several classes of cyclic nitroxides that can be employed in the practice of the present invention can be presented by the following structural formula: 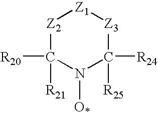
wherein Z₁, Z₂ and Z₃ are independently selected from the group consisting of oxygen, sulfur, secondary amines, tertiary amines, phosphorus of various oxidation states, and substituted and unsubstituted carbon atoms, such as >CH₂, >CHCH₃, >C═O, >C(CH₃)₂, >CHBr, >CHCl, >CHI, >CHF, >CHOH, >CHCN, >CH(OH)CN, >CHCOOH, >CHCOOCH₃, >CHC₂H₅, >C(OH)COOC₂H₅, >C(OH)COOCH₃, >C(OH)CH(OH)C₂H₅, >CR₂₀OR₂₁, >CHNR₂₀R₂₁, >CCONR₂₀R₂₁, >C═NOH, >C═CH—C₆H₅, >CF₂, >CCl₂, >CBr₂, >CI₂, and the like. Additional useful stable hindered nitroxyl inhibitors are described on patent publications WO 01/40404 A1, WO01/40149 A2, WO 01/42313 A1, U.S. Pat. No. 4,141,883, U.S. Pat. No. 6,200,460 B1, U.S. Pat. No. 5,728,872, incorporated here in their entirety.

Other inhibitors that may be used include oxime compounds of the following formula: 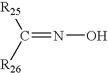
where R₂₅ and R₂₆ are the same or different and are hydrogen, alkyl, aryl, aralkyl, alkylhydroxyaryl or arylhydroxyalkyl groups having three to about 20 carbon atoms. Those skilled in the art will find valuable advice for choosing these components in international patent WO 98/14416.

The unsaturated polyester polyol resin also includes a polymerization initiator or other agent such as an organic peroxide compound to facilitate curing of the composition such as described in U.S. application Ser. No. 10/961,862, the disclosure of which is incorporated by reference in its entirety. Exemplary organic peroxides that are selected from a list that includes, but is not limited to, the following: diacyl peroxides such as benzoyl peroxides, t-butyl peroxybenzoate; t-amyl peroxybenzoate; ketone peroxides such as mixtures of peroxides and hydroperoxides; methyl isobutyl ketone; 2,4-pentanedione peroxide; methyl ethyl ketone peroxide/perester blend; peroxydicarbonates such as di(n-propyl)peroxydicarbonate, di(sec-butyl)peroxydicarbonate; di(2Z-ethylhexyl) peroxydicarbonate; bis(4-t-butyl-cyclohexyl) peroxydicarbonate; diisopropyl peroxydicarbonate; diacetyl peroxydicarbonate; peroxyesters such as alpha-cumyl peroxydecanoate; alpha-cumyl peroxyneoheptanoate; t-butylperoxyneodecanoate; t-butylperoxypivalate; 1,5-dimethyl 2,5-di(2-ethylhexanoyl peroxy)hexane; t-butylperoxy-2-ethylhexanoate; t-butylperoxy isobutyrate; t-butylperoxymaleic acid; t-butyl-isopropyl carbonate-2,5-dimethyl-2,5-di(benzoylperoxy)hexane; t-butylperoxy-acetate; t-butylperoxybenzoate; di-t-butylperoxy acetate; t-butyl peroxybenzoate; di-t-butyl diperoxyphthalate; mixtures of the peroxy esters and peroxyketal; t-amylperoxyneodecanoate; t-amylperoxypivalate; t-amylperoxy(2-ethylhexanoate); t-amylperoxyacetate; t-amylperoxy(2-ethylhexanoate); t-amylperoxyacetate; t-amylperoxybenzoate; t-butylperoxy-2-methyl benzoate; dialkylperoxides such as dicumyl peroxide; 2,5-dimethyl-2,5-di(t-butylperoxy)hexane; 2,5-dimethyl-2,5-di(t-butylperoxy)dexyne-3; t-butyl cumyl peroxide; α,α-bis(t-butylperoxy)diisopropylbenzene; di-t-butyl peroxide; hydroperoxides such as 2,5-dihydroperoxy-2,5-dimethylhexane; cumene hydroperoxide; t-butylhydroperoxide; peroxyketals such as 1,1-di(t-butylperoxy) 3,3,5-trimethylcyclohexane; 1,1-di(t-butylperoxy)cyclohexane; ethyl-3,3-di(t-butylperoxy) butyrate; n-butyl 4,4-bis(t-butylperoxy)pivalate; cyclic peroxyketal; 1,1-di(t-amylperoxy)cyclohexane; 2,2-di-t-amylperoxy propane; azo type initiators such as 2,2′-azobis(2,4-dimethylvaleronitrile); 2,2′azobis(isobutyronitrile); 2,2′azobis(methylbutyronitrile); 1,1′-azobis(cyanocyclohexane).

Initiators that can be used in accordance with the invention can be any compound that has one or more atoms or atomic groups that are radically transferable under the polymerization conditions.

Suitable initiators include those of the formulas:
R₁₁R₁₂R₁₃C—X
R₁₁C(═O)—X
R₁₁R₁₂R₁₃Si—X
R₁₁R₁₂N—X
R₁₁N—X₂
(R₁₁)ₙP(O)ₘ—X₃₋ₙ
(R₁₁O)ₙP(O)ₘ—X₃₋ₙand
(R₁₁)(R₁₂O)P(O)ₘ—X,
where X is selected from group consisting of Cl, Br, I, OR₁₀, [where R₁₀ is an alkyl group with 1 to 10 carbon atoms, where each hydrogen atom can be independently be placed by a halide, preferably chloride or fluoride, an alkenyl with 2 to 20 carbon atoms, preferably vinyl, an alkynyl with 2 to 10 carbon atoms, preferably acetylenyl or phenyl, which can be substituted with 1 to 5 halogen atoms or alkyl groups with 1 to 4 carbon atoms, or aralkyl or alkyl groups with 1 to 4 carbon atoms, or aralkyl (aryl-substituted alkyl alkyl in which the aryl group is phenyl or substituted phenyl and the alkyl group is an alkyl with 1 to 6 carbon atoms, such as benzyl, for example)], SR₁₄, SeR₁₄, OC(═O)R₁₄, OP(═O)R₁₄, OP(═O)(OR₁₄)₂, OP(═O)OR₁₄, O—N(R₁₄)₂, S—C(═S)N(R₁₄)₂, CN, NC, SCN, CNS, OCN, CNO and N₃, where R₁₄ means an alkyl group or a linear or branch alkyl group with 1 to 20, preferably 1 to 10 carbon atoms, where two R₁₄ groups, if present, together can form a 5, 6, or 7-member heterocyclic ring; and R₁₁, R₁₂ and R₁₃ are independently chosen from the group consisting of hydrogen, halogens, alkyl groups with 1 to 20, preferably 1 to 10 and specially 1 to 6 carbon atoms, cycloalkyl groups with 3 to 8 carbon atoms, (R₈)₃Si, C(═Y)R₅, C(═Y)NR₆R₇, where Y, R₅, R₆ and R₇ are defined as above, COCl, OH, (preferably one of the residues R₁₁, R₁₂ and R₁₃ is OH), CN, alkenyl or alkynyl groups with 2 to 20 carbon atoms, preferably 2 to 6 carbon atoms and specially preferably allyl or vinyl, oxiranyl, glycidyl, alkylene or alkenylene groups with 2 to 6 carbon atoms, which are substituted with oxiranyl or glycidyl, aryl, heterocyclyl, aralkyl, aralkenyl (aryl-substituted alkenyl, where aryl is defined as above and alkenyl is vinyl, which is substituted with one or two C₁ to C₆ alkyl groups and/or halogen atoms, preferably with chlorine), alkyl groups with 1 to 6 carbon atoms, in which one up to all of the hydrogen atoms, preferably one, is/are substituted by halogen (preferably fluorine or chlorine, if one or more hydrogen atoms are replaced, and preferably fluorine, chlorine or bromine, if one hydrogen atom is replaced), alkyl groups with 1 to 6 carbon atoms, which with 1 to 3 substituents (preferably 1) are chosen from the group consisting of C₁-C₄ alkoxy, aryl, heterocyclyl, C(═Y)R₅, (where R₅ is defined as above), C(═Y)NR₆R₇ (where R₆ and R₇ are defined as above), oxiranyl and glycidyl (preferably not more than 2 of the residues R₁₁, R₁₂ and R₁₃ are hydrogen, especially preferably a maximum of one of the residues R₁₁, R₁₂ and R₁₃ is hydrogen); m is 0 to 1; and n is 0, 1 or 2.

Among the specially preferred initiators are benzyl halides like p-chloromethyl styrene, α-dichloroxylene, α,α-dichloroxylene, α,α-dibromoxylene and hexakis(α-bromomethyl)benzene, benzyl chloride, benzyl bromide, 1-bromo-1-phenylethane and 1-chloro-1-phenylethane; carboxylic acids derivatives that are halogenated in alfa position, such as propyl 2-bromopropionate, methyl 2-chloropropionate, ethyl 2-chloropropionate, methyl 2-bromopropionate, ethyl 2-bromoisobutyrate, tosyl halides such as p-toluenesulfonyl chloride; alkyl halides like tetrachloromethane, tribromomethane, 1-vinylethyl chloride, 1-vinylethyl bromide, 1-vinylethyl bromide; and halogen derivatives of phosphoric acid esters like dimethyl phosphoric chloride. Additional useful initiators and the various radically transferable groups that may be associated with them are described in WO 97/47661, the disclosure of which is incorporated by reference.

Polymeric compounds (including oligomeric compounds) having radical transferable groups may be used as initiators, and are herein referred as “macroinitiators.” Examples of macroinitiators include, but are not limited to, polystyrene prepared by cationic polymerization and having a terminal halide, e.g., chloride, (chloromethyl) polystyrene prepared by radical polymerization, (chloromethyl) polystyrene co-polystyrene prepared by radical polymerization, a polymer of 2-(2-bromopropionoxy) ethyl acrylate and one or more alkyl (meth)acrylates, e.g., butyl acrylate, prepared by conventional non-living radical polymerization. Macroinitiators can be used to prepared graft polymers, such as grafted block compolymers and comb compolymers. A further discussion of macroinitiators is found in U.S. Pat. No. 5,789,487, the disclosure of which is incorporated by reference in its entirety.

The initiator may include: 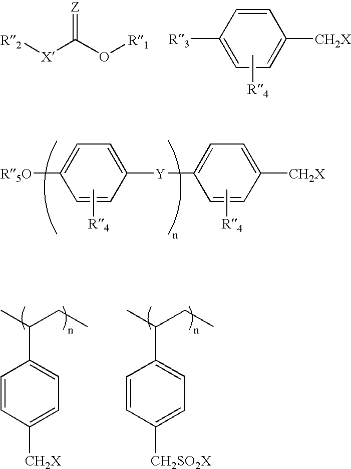 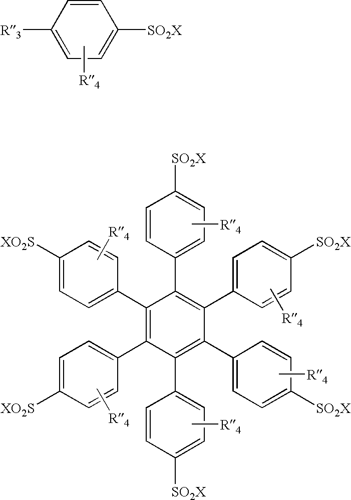 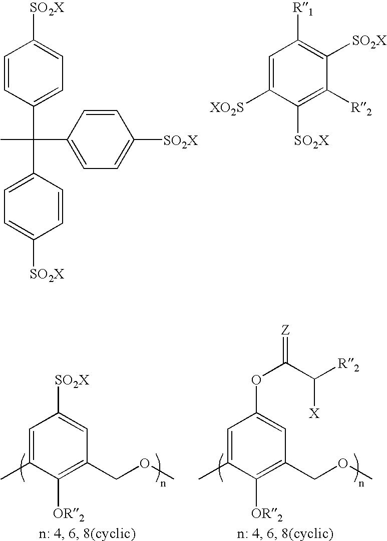
Where: R″₁ is a H, C₁ to C₂₀ hydrocarbon chain that may be linear or branch and may contain 1 to 5 hydroxy, thiol or amino groups, or a combination of them.
R″₂ is a H, C₁ to C₂₀ hydrocarbon chain that may be linear or branch and may contain 1 to 5 hydroxy, thiol or amino groups, or a combination of them.
R″₃ is a H, OH, COOR₁, SH, SO₂X, NHR₁, NH₂, R″₁P(O), C₁ to C₂₀ hydrocarbon chain that may be linear or branch and may contain 1 to 5 hydroxy, thiol or amino groups, or a combination of them.
R″₄ is a Br, C₁, F, I, H, OH, SH, SO₂X, R″₁P(O), C₁ to C₂₀ hydrocarbon chain that may be linear or branch and may contain 1 to 5 hydroxy, thiol or amino groups, or a combination of them.
R″₅ is a H, R″₁P(O), C₁ to C₂₀ hydrocarbon chain that may be linear or branch and may contain 1 to 5 hydroxy, thiol or amino groups, or a combination of them.
X is a Br, Cl, I
Y is a O, C(O), COO, S, S(O), SO₂, NH, CH₂, R″₁P(O).

Preferably, the initiator may be selected from the group consisting of halomethane, methylenedihalide, haloform, carbon tetrachloride, methanesulfonyl halide, p-toluenesulfonyl halide, methanesulfenyl halide, p-toluenesulfenyl halide, 1-phenylethyl halide, 2-halopropionitrile, C₁-C₆-alkyl ester of 2-halo-C₁-C₆-carboxylic acid, p-halomethyl styrene, mono-hexakis (α-halo-C₁-C₆-alkyl)benzene, diethyl-2-halo-2methyl malonate, benzyl halide, ethyl 2-bromoisobutyrate and mixtures thereof.

Additional useful initiators and the various radically transferable groups that may be associated with them are described in international patent publication WO 96/30421, the disclosure of which is incorporated by reference herein in its entirety.

The initiator is in general used in a concentration in the range of 10⁻⁴ mol/L to 3 mol/L, preferably in the range of 10⁻³ mol/L to 10⁻¹ mol/L and especially preferably in the range of 5×10⁻² mol/L to 5×10⁻¹ mol/L, without any limitations included by this. The molecular weight of the polymer results from the ratio of the initiator to monomer, if all the monomer is converted. Preferably this ratio lies in the range of 10⁻⁴ to 1 up to 0.5 to 1, especially in the range of 5×10⁻³ to 1 up to 5×10⁻² to 1.

The preferred curing catalysts are: t-butyl peroxybenzoate; t-amyl peroxybenzoate; t-butylperoxy-2-ethylhexanoate; di-t-butyl peroxide; 1,1-di(t-butylperoxy) 3,3,5-trimethylcyclohexane; 1,1-di(t-butylperoxy)cyclohexane; ethyl-3,3-di(t-butylperoxy) butyrate.

Mixtures of any of the above may be used. The curing catalyst is preferably employed in an amount from about 0.3 to 5.0 percent based on the weight of the resin, more preferably from about 1.5 to 2.5 percent by weight, and most preferably from about 1 to 1.25 percent by weight. Other additives may include moisture scavenger, fire retardants, reactions catalysts for the urethane portion and high molecular weight unsaturated polyesters.

Other components in the resin may include epoxy acrylate oligomers known to those who are skilled in the art. As an example, the term “epoxy acrylates oligomer” may be defined for the purposes of the invention as a reaction product of acrylic acid and/or methacrylic acid with an epoxy resin. Examples of processes involving the making of epoxy acrylates can be found in U.S. Pat. No. 3,179,623, the disclosure of which is incorporated herein by reference in its entirety. Epoxy resins that may be employed are known and include virtually any reaction product of a polyfunctional halohydrin, such as, but not limited to, epichlorohydrin, with a phenol or polyhydric phenol. Examples of phenols or polyhydric phenols include, but are not limited to, resorcinol, tetraphenol ethane, and various bisphenols such as Bisphenol-A, 4,4′-dihydroxy biphenyl, 4,4′-dihydroxydiphenylmethane, 2,2′-dihydroxydiphenyloxide, phenol or cresol formaldehyde condensates and the like. Mixtures of any of the above can be used. The preferred epoxy resins employed in forming the epoxy acrylates are those derived from bisphenol A, bisphenol F, especially preferred are their liquid condensates with epichlorohydrin having a molecular weight preferably in the range of from about 300 to about 800. The preferred epoxy acrylates that are employed of the general formula: 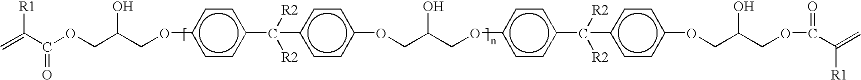
where R1 and R2 is H or CH₃ and n ranges from 0 to 1, more preferably from 0 to 0.3.

Other examples of epoxy acrylate oligomers that may be used include comparatively low viscosity epoxy acrylates. As an example, these materials can be obtained by reaction of epichlorohydrin with the diglycidyl ether of an aliphatic diol or polyol.

The vinyl ester resins may be included and are the reaction product of an unsaturated monocarboxylic acid or anhydride with an epoxy resin. Exemplary acids and anhydrides include (meth)acrylic acid or anhydride, α-phenylacrylic acid, α-chloroacrylic acid, crotonic acid, mono-methyl and mono-ethyl esters of maleic acid or fumaric acid, vinyl acetic acid, sorbic acid, cinnamic acid, and the like, along with mixtures thereof. Epoxy resins which may be employed are known and include virtually any reaction product of a polyfunctional halohydrin, such as epichlorohydrin, with a phenol or polyhydric phenol. Suitable phenols or polyhydric phenols include, for example, resorcinol, tetraphenol ethane, and various bisphenols such as Bisphenol “A”, 4,4′-dihydroxydiphenyl sulfone, 4,4′-dihydroxy biphenyl, 4,4′-dihydroxydiphenyl methane, 2,2′-dihydoxydiphenyloxide, and the like. Novolac epoxy resins may also be used. Mixtures of any of the above may be used. Additionally, the vinyl ester resins may have pendant carboxyl groups formed from the reaction of esters and anhydrides and the hydroxyl groups of the vinyl ester backbone.

A particularly preferred epoxy acrylate oligomer is an epoxy (meth)acrylate oligomer. Various quantities of epoxy acrylate oligomer may be used. Preferably, the laminating resin composition comprises from about 5 to about 50 percent by weight of epoxy acrylate monomer, and more preferably from about 5 to about 30 percent by weight.

DCPD resins used in the composition of the invention are known to those skilled in the art. These resins are typically DCPD polyester resins and derivatives which may be made according to various accepted procedures. As an example, these resins may be made by reacting DCPD, ethylenically unsaturated dicarboxylic acids, and compounds having two groups wherein each contains a reactive hydrogen atom that is reactive with carboxylic acid groups. DCPD resins made from DCPD, maleic anhydride phthalic anhydride, isophthalic acid, terephthalic acid, adipic acid, water, and a glycol such as, but not limited to, ethylene glycol, propylene glycol, diethylene glycol, neopentyl glycol, dipropylene glycol, and poly-tetramethylene glycol, are particularly preferred for the purposes of the invention. The DCPD resin may also include nadic acid ester segments that may be prepared in-situ from the reaction of pentadiene and maleic anhydride or added in its anhydride form during the preparation of the polyester. The DCPD resin may be used in various amounts in the laminating resin composition of the invention. Preferably, the laminating resin composition comprises from about 10 to about 80 weight percent of DCPD resin, and more preferably from about 20 to about 40 weight percent. Preferably, the DCPD resin has a number average molecular weight ranging from about 450 to about 1500, and more preferably from about 500 to about 1000. Additionally, the DCPD resin preferably has an ethylenically unsaturated monomer content of below 35 percent at an application viscosity of 500 cps.

Polyacrylates are also useful in the preparation of the molding compositions. A urethane poly(acrylate) characterized by the following empirical formula may used as part of the mixtures: 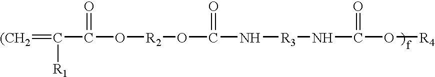
wherein R₁ is hydrogen or methyl; R₂ is a linear or branched divalent alkylene or oxyalkylene radical having from 2 to 5 carbon atoms; R₃ is a divalent radical remaining after reaction of a substituted or unsubstituted diisocyanate; R₄ is the hydroxyl free residue of an organic polyhydric alcohol which contained hydroxyl groups bonded to different atoms; and f has an average value of from 2 to 4. The compounds are typically the reaction products of polyols in which the hydroxyl groups are first reacted with a diisocyanate using one equivalent of diisocyanate per hydroxyl group, and the free isocyanate groups are the reacted with a hydroxyalkyl ester of acrylic or methacrylic acid.

The polyhydric alcohol suitable for preparing the urethane poly(acrylate) typically contains at least two carbon atoms ad may contain from 2 to 4, inclusive, hydroxyl groups. Polyols based on the polycaprolactone ester of a polyhydric alcohol such as described in, for example U.S. Pat. No. 3,169,945 are included. Unsaturated polyols may also be used such as those described in U.S. Pat. Nos. 3,929,929 and 4,182,830.

Diisocyanates suitable for preparing the urethane poly(acrylate) are well known in the art and include aromatic, aliphatic, and cycloaliphatic diisocyanates. Such isocyanates may be extended with small amounts of glycols to lower their melting point and provide a liquid isocyanate. The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however.

Urethane poly(acrylates) such as the above are described in for example, U.S. Pat. Nos. 3,700,643; 4,131,602; 4,213,837; 3,772,404 and 4,777,209, the disclosures of which are incorporated herein by reference in their entirety.

A urethane poly(acrylate) characterized by the following empirical formula: 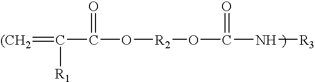
where R₁ is hydrogen or methyl; R₂ is a linear or branched alkylene or oxyalkylene radical having from 2 to about 6 carbon atoms; R₃ is the polyvalent residue remaining after the reaction of a substituted or unsubstituted polyisocyanate; and g has an average value of from about 2 to 4. These compounds are typically the reaction products of a polyisocyanate with a hydroxyalkyl ester per isocyanate group.

Polyisocyanates suitable for preparing the urethane poly(acrylates) are well known in the art and include aromatic, aliphatic and cycloaliphatic polyisocyanates. Some diisocyanates may be extended with small amounts of glycol to lower their melting point and provide a liquid isocyanate.

Urethanes poly(acrylates) such as the above are described in, for example U.S. Pat. No. 3,297,745 and British Pat. No. 1,159,552, the disclosures of which are incorporated herein by reference in their entirety.

A half-ester or half-amide characterized by the following formula: 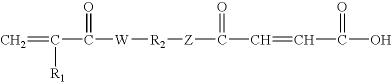
wherein R₁ is hydrogen or methyl. R₂ is an aliphatic or aromatic radical containing from 2 to about 20 carbon atoms, optionally containing —O— or 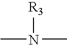
W and Z are independently —O— or 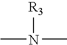
And R₃ is hydrogen or low alkyl. Such compounds are typically the half-ester or half-amide product formed by the reaction of a hydroxyl, amino, or alkylamino containing ester or amide derivatives of acrylic or methacrylic acid with maleic anhydride, maleic acid, or fumaric acid. These are described in, for example, U.S. Pat. Nos. 3,150,118 and 3,367,992, the disclosures of which are incorporated herein by reference in their entirety.

An unsaturated isocyanurate characterized by the following empirical formula: 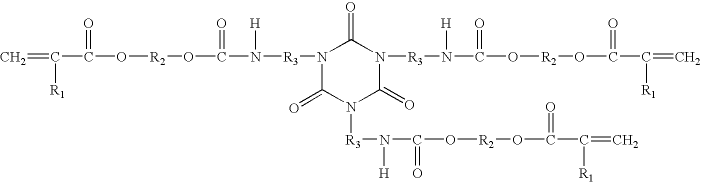
wherein R₁ is a hydrogen or methyl, R₂ is a linear or branched alkylene or oxyalkylene radical having from 2 to 6 carbon atoms, and R₃ is a divalent radical remaining after reaction of a substituted or unsubstituted diisocyanate. Such products are typically produced by the trimerization reaction of a diisocyanate followed by reaction of the remaining free isocyanate groups with a hydroxyalkyl ester of acrylic or methacrylic acid.

It is understood that during the formation of the isocyanurate, a diisocyanate may participate in the formation of two isocyanurate rings thereby forming crosslinked structures in which the isocyanurate rings may be linked by the diisocyanate used. Polyisocyanates might also be used to increase this type of crosslink formation.

Diisocyanates suitable for preparing the urethane poly(acrylate) are well known in the art and include aromatic, aliphatic, and cycloaliphatic diisocyanates. Such isocyanates may extended with small amounts of glycols to lower their melting point and provide a liquid isocyanate.

The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however.

Such unsaturated isocyanurates are described in, for example, U.S. Pat. No. 4,195,146.

Poly(amide-esters) as characterized by the following empirical formula: 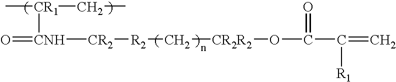
wherein R₁ is independently hydrogen or methyl, R₂ is independently hydrogen or lower alkyl, and h is 0 or 1. These compounds are typically the reaction product of a vinyl addition prepolymer having a plurality of pendant oxazoline or 5,6-dihydro-4H-1,3-oxazine groups with acrylic or methacrylic acid. Such poly(amide-esters) are described in, for example, British Pat. No. 1,490,308.

A poly(acrylamide) or poly(acrylate-acrylamide) characterized by the following empirical formula: 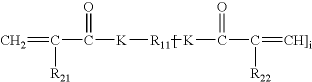
wherein R₁ is the polyvalent residue of an organic polyhydric amine or polyhydric aminoalcohol which contained primary or secondary amino groups bonded to different carbon atoms or, in the case of an aminoalcohol, amine and alcohol groups bonded to different carbon atoms; R₂ and R₃ are independently hydrogen or methyl; K is independently —O— or 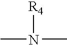
R₄ is hydrogen or lower alkyl; and i is 1 to 3.

The polyhydric amines suitable for preparing the poly(acrylamide) contains at least two carbon atoms and may contain 2 to 4, inclusive, amine or alcohol groups, with the proviso that at least one group is a primary or a secondary amine. These include alkane aminoalcohols and aromatic containing aminoalcohols. Also included are polyhydric aminoalcohols containing ether, amino, amide, and ester groups in the organic residue.

Examples of the above compounds are described, in for example, Japanese publications Nos. JP80030502, JP80030503, and JP800330504 and U.S. Pat. No. 3,470,079 and British Pat. No. 905,186, the disclosures of which are incorporated herein by reference in their entirety.

It is understood by those skilled in the art that the thermosettable organic materials described, supra, are only representative of those which may be used in the practice of this invention.

Additional additives known by the skilled artisan may be employed in the resin composition of the present invention including, for example, paraffins, fatty acids, fatty acid derivatives, lubricants, flow agents, air release agents, flow agents, wetting agents, UV stabilizers, and shrink-reducing additives. Various percentages of these additives can be used in the resin compositions.

Fatty acids may be used in the preparation of polyesters without restriction. Although prepolymerized fatty acids or their fatty acid esters prepared according to known processes are usually used. A polybasic polymerized fatty acid prepared by polymerizing a higher fatty acid or higher fatty acid ester is preferable because can provide better adhesiveness, flexibility, water resistant and heat resistance, providing a well balance mixture with improved properties. The fatty acid may be any of saturated and unsaturated fatty acids, and the number of carbons may be from 8 to 30, preferably 12 to 24, and further preferably 16 to 20. As the fatty ester, alkyl esters, such as methyl, ethyl, propyl, butyl, amyl and cyclohexyl esters and the like.

Preferable polymerized fatty acids include polymerized products of unsaturated higher fatty acids such as oleic acid, linoleic acid, resinoleic acid, eleacostearic acid and the like. Polymerized products of tall oil fatty acid, beef tallow fatty acid and the like, etc., can be also used. Hydrogenated polymerized fatty esters or oils can also be used. Portions of the dibasic carboxylic acid (herein after referred to as “dimer acid”) and three or higher basic carboxylic acid in the polymerized fatty acid is not particularly limited, but the proportions may be selected appropriately according to the ultimate properties expected. Trimer acids or higher carboxylic acids may also be used.

The polymerization of the fatty acid esters is not particularly limited, alkyl esters of the above mentioned polymerized fatty acids are usually used as the polymerized fatty acid esters. As said alkyl esters such as methyl ester, ethyl ester, propyl ester, isopropyl ester, butyl ester, amyl ester, hexyl ester and the like and higher alkyl esters such as octyl ester, decyl ester, dodecyl ester, pentadecyl ester, octadecyl ester and the like can be used, among which preferable are lower alkyl esters and more preferable are methyl ester, ethyl ester and butyl ester.

These polymerized fatty acids and polymerized fatty acid esters can be used either alone or in combination of two or more. Although proportion of the sum of the polymerized fatty acids and the polymerized fatty acid esters in the total polybasic carboxylic acid is not particularly limited and may be used in different rations ranging from 3 to 40% by weight of the resin composition.

Also compounds that may be included in this invention are epoxy compounds which include a wide variety of epoxy compounds. Typically, the epoxy compounds are epoxy resins which are also referred as polyepoxides. Polyepoxides useful herein can be monomeric (i.e. the diglycidyl ether of bisphenol A), advanced higher molecular weight resins, or polymerized unsaturated monoepoxides (i.e., glycidyl acrylates, glycidyl methacrylates, allyl glycidyl ether, etc.) to homopolymers or copolymers. Most desirable, epoxy compounds contain, on the average, at least one pendant or terminal 1,2-epoxy group (i.e., vicinal epoxy group per molecule).

Examples of the useful polyepoxides include the polyglicidyl ethers of both polyhydric alcohols and polyhydric phenols; polyglycidyl amines, polyglycidyl amides, polyglycidyl imides, polyglycidyl hydantoins, polyglycidyl thioethers, polyglycidyl fatty acids, or drying oils, epoxidized polyolefins, epoxidized di-unsaturated acid esters, epoxidized unsaturated polyesters, and mixtures thereof. Numerous epoxides prepared from polyhydric phenols include those which are disclosed, for example, in U.S. Pat. No. 4,431,782, the disclosure of which is incorporated by reference in its entirety. Polyepoxides can be prepared from mono-, di- and trihydric phenols, and can include the novolac resins. The polyepoxides can include the epoxidized cycloolefins; as well as the polymeric polyepoxides which are polymers and copolymers of glycidyl acrylates, glycidyl methacrylate and allylglycidyl ether. Suitable polyepoxides are disclosed in U.S. Pat. Nos. 3,804,735; 3,893,829; 3,948,698; 4,014,771 and 4,119,609; and Lee and Naville, Handbook of Epoxy Resins, Chapter 2, McGraw Hill, New York (1967).

While the invention is applicable to a variety of polyepoxides, generally preferred polyepoxides are glycidyl polyethers of polyhydric alcohols or polyhydric phenols having weights per epoxide of 150 to 2,000. These polyepoxides are usually made by reacting at least about two moles of an epihalohydrin or glycerol dihalohydrin with one mole of the polyhydric alcohol or polyhydric phenol, and sufficient amount of a caustic alkali to combine with the halogen of the halohydrin. The products are characterized by the presence of more than one epoxide group, i.e., a 1,2-epoxy equivalency greater than one.

The compositions may also include a monoepoxide, such as butyl glycidyl ether, phenyl glycidyl ether, or cresyl glycidyl ether, as a reactive diluent. Such reactive diluents are commonly added to polyepoxide formulations to reduce the working viscosity thereof, and to give better wetting to the formulation.

Internal release agents are preferably added to the molding composition according to the invention. Aliphatic metal salts such as zinc stearate, magnesium stearate, calcium stearate or aluminum stearate can be used as the internal release agent. The amount of internal release agent added is in the range of 0.5 to 5.0% by weight, more preferably in the range of from 0.4% to 4.0% by weight. Hence, stable release can be made at the time of demolding without occurrence of any crack on the molded product.

Metal salts that contain at least one transition metal may be used to accelerate the curing process. Here any transition metal compound that can produce a redox cycle with the chain transfer agent or the polymer chain that has a transferable atomic group can be used. In these cycles the transferable atomic group and the catalyst reversibly form a compound, with the degree of oxidation of the transition metal being increased or decreased. Here one assumes that the radicals are released or trapped, so that the concentration of radicals stays very low. Preferred transition metal compounds are those which do not form a direct carbon-metal bond with the polymer chain. Particularly suitable transition metal compounds are those of the formula Mⁿ⁺X′ where:

Mⁿ⁺ may be for example, selected from the group consisting of Cu¹⁺, Cu²⁺, Au⁺, Au²⁺, Au³⁺, Ag⁺, Ag²⁺, Hg⁺, Hg²⁺, Ni^{o}, Ni⁺, Ni²⁺, Ni³⁺, Pd^{o}, Pd⁺, Pd²⁺, Pt^{o}, Pt⁺, Pt²⁺, Pt³⁺, Pt⁴⁺, Rh⁺, Rh²⁺, Rh³⁺, Rh⁴⁺, Co⁺, Co²⁺, Co³⁺, Ir^{o}, Ir⁺, Ir²⁺, Ir³⁺, Ir⁴⁺, Fe²⁺, Fe³⁺, Ru²⁺, Ru³⁺, Ru⁴⁺, Ru⁵⁺, Ru⁶⁺, Os²⁺, Os³⁺,Os⁴⁺, Re²⁺, Re³⁺, Re⁴⁺, Re⁶⁺, Re⁷⁺, Mn³⁺, Mn⁴⁺, Cr²⁺, Cr³⁺, Mo^{o}, Mo⁺, Mo²⁺, Mo³⁺, W²⁺, W³⁺, V²⁺, V³⁺, V⁴⁺, V⁵⁺, Nb²⁺, Nb³⁺, Nb⁴⁺, Nb⁵⁺, Ta³⁺, Ta⁴⁺, Ta⁵⁺, Zn⁺ and Zn²⁺;

X′ may be for example, selected from the group consisting of halogen, OH, (O)_{1/2}, C₁-C₆-alkoxy, (SO₄)_{1/2}, (PO₄)_{1/3}, (HPO₄)_{1/2}, (H₂PO₄), triflate, hexafluoroborate, methane sulfonate, arylsulfonate (preferably benzensulfonate or toluenesulfonate), SeR₁₄, CN, NC, SCN, CNS, OCN, CNO, N₃ and R₁₅COO₂, where R₁₄ is defined above and R₁₅ is H or a straight or branched C₁-C₆ alkyl group (preferably methyl) or aryl (preferably phenyl) which may be substituted from 1 to 5 times with a halogen (preferably 1 to 3 times with fluorine or chlorine); and N is the formal charge on the metal (e.g., 0≦n≧7). Among the preferred metallic compounds are salt from Co, Zn, Ni and Cu.

The molar ratio of transition metal lies in general in the range of 0.0001% to 10.0%, preferably in the range of 0.001% to 5.0% and especially preferably in the range of 0.01% to 2.0%, without this intending to imply any limitation.

Other suitable curing accelerators or promoters that optionally may be used include, for example, cobalt naphthanate, cobalt octoate, N,N-diethyl aniline, N,N-dimethyl aniline, N,N-dimethyl acetamide, and N,N-dimethyl p-toluidine. Other salts of lithium, potassium, zirconium, calcium and copper. Mixtures of the above may be used. The curing accelerators or promoters are preferably employed in amounts from about 0.005 to about 1.0 percent by weight, more preferably from about 0.1 to 0.5 percent by weight, and most preferably from about 0.1 to 0.3 percent by weight of the resin.

Saturated polyester and polyurethanes include, for example, those described in U.S. Pat. Nos. 4,871,811, 3,427,346 and 4,760,111, the disclosures of which are incorporated herein by reference in its entirety. The saturated polyester resins and polyurethanes are particularly useful in hand lay-up, spray up, sheet molding compounding, hot melt adhesives and pressure sensitive adhesives applications. Appropriate saturated polyester resins include, but are not limited to, crystalline and amorphous resins. The resins may be formed by any suitable technique. For example, the saturated polyester resin may be formed by the polycondensation of an aromatic or aliphatic di- or polycarboxylic acid and an aliphatic or alicyclic di- or polyol or its prepolymer. Optionally, either the polyols may be added in an excess to obtain hydroxyl end groups or the dicarboxylic monomers may be added in an excess to obtain carboxylic end groups. Suitable polyurethane resins may be formed by the reaction of diols or polyols as those described in U.S. Pat. No. 4,760,111 and diisocyantes. The diols are added in an excess to obtain hydroxyl terminal groups at the chain ends of the polyurethane. The saturated polyesters and polyurethanes may also contain other various components such as, for example, an ethylene-vinyl acetate copolymer, an ethylene-ethyl acrylate copolymer, polystyrene, polymethyl methacrylate, polystyrene co-polymethyl methacrylate copolymers and the like.

The process of the invention may employ a carbodiimide, preferably a carbodiimide intermediate containing from about 1 to about 1000 repeating units. Polycarbodiimides are preferably utilized. The carbodiimides depending on the amount added are used to react with the resin or components having active hydrogens. For example to lower the acid number of the unsaturated polyester resin. Exemplary carbodiimides are described in U.S. Pat. No. 5,115,072 to Nava et al., the disclosure of which is incorporated herein by reference in its entirety.

In general, the carbodiimides preferably are polycarbodiimides that include aliphatic, cycloaliphatic, or aromatic polycarbodiimides. The polycarbodiimides can be prepared by a number of reaction schemes known to those skilled in the art. For example, the polycarbodiimides may be synthesized by reacting an isocyanate-containing intermediate and a diisocyanate under suitable reaction conditions. The isocyanate containing intermediate may be formed by the reaction between a component, typically a monomer containing active hydrogens, and a diisocyanate. Included are also polycarbodiimides prepared by the polymerization of isocyanates to form a polycarbodiimide, which subsequently react with a component containing active hydrogens.

Preferably, the carbodiimide intermediate is represented by the formula selected from the group consisting of: 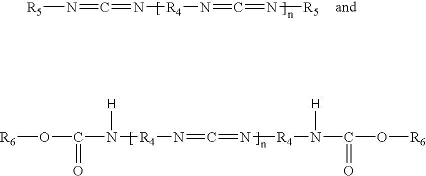
wherein:

R₄ and R₅ are independently selected from the group consisting of alkyl, aryl, and a compound containing at least one radical;

R₆ may be a monomeric unit or a polymeric unit having from 1 to 1000 repeating units; and

n ranges from 0 to 100;

The carbodiimide is preferably used in an percentage ranging from about 0.10 to about 50 based on the weight of reactants, and more preferably from about 1 to about 20 percent.

Various hydroxyl and carboxyl terminated rubbers may be also used as toughening agents. Examples of such materials are presented in U.S. Pat. No. 4,100,229, the disclosure of which is incorporated by reference herein in its entirety; and in J. P. Kennedy, in J. Macromol. Sci. Chem. A21, pp. 929(1984). Such rubbers include, for example, carbonyl-terminated and hydroxyl polydienes. Exemplary carbonyl-terminated polydienes are commercially available from BF Goodrich of Cleveland, Ohio, under the trade name of Hycar™. Exemplary hydroxyl-terminated Polydienes are commercially available from Atochem, Inc., of Malvern, Pa., and Shell Chemical of Houston, Tex.

A number of polysiloxanes may be used as toughening agents. Examples of suitable polysiloxanes include poly(alkylsiloxanes), (e.g., poly(dimethyl siloxane)), which includes compounds which contain silanol, carboxyl, and hydroxyl groups. Examples of polysiloxanes are described in Chiang and Shu, J. Appl. Pol. Sci. 361, pp. 889-1907, (1988).

Various hydroxyl and carboxyl terminated polyesters prepared from lactones (e.g., gamma-butyrolactone, etha-caprolactone), as described in Zhang and Wang, Macromol. Chem. Phys. 195, 2401-2407(1994); In't Velt et al., J. Polym. Sci. Part A, 35, 219-216(1997); Youqing et al., Polym. Bull. 37, 21-28(1996).

Various Telechelic Polymers as those described in “Telechelic Polymers: Synthesis and Applications”, Editor: Eric J. Goethals, CRC Press, Inc. 1989., are also included in this invention.

Various polyethoxylated and polypropoxylated hydroxyl terminated polyethers derived from alcohols, phenols (including alkyl phenols), and carboxylic acids can be used as toughening agents. Alcohols which may be used in forming these materials include, but are not limited to, tridecyl alcohol, lauryl alcohol, oleyl alcohol, and mixtures thereof. Commercially suitable polyethoxylated and polypropoxylated oleyl alcohol are sold under the trade name of Rhodasurf™ by Rhone-Poulenc of Cranbury, N.J., along with Trycol™ by Emery Industries of Cincinnati, Ohio. Examples of phenols and alkyl phenols which may be used include, but are not limited to, octyl phenol, nonyl phenol, tristyrylphenol, and mixtures thereof. Commercially suitable tristyrylphenols include, but are not limited to, Igepal™ by Rhone-Poulenc, along with Triton™ by Rohm and Haas of Philadelphia, Pa.

The vinyl monomers and polyfunctional acrylates used with the vinyl esters, unsaturated polyesters, saturated polyesters, and polyurethanes may be used in varying amounts, preferably from about 10 to 50 based on the weight of the components which may be dissolved therein, and more preferably from about 20 to 40 weight percent.

The resins in accordance with the invention can be used individually or as a mixture, where the term mixture is to be understood broadly. It includes both mixtures of different polymers of this invention as well as mixtures of copolymers prepared by condensation, addition polymerization and radical polymerization, such polymers include: saturated polyester resins, unsaturated polyesters (e.g., resins used in forming molded articles), aliphatic and aromatic polyethers, vinyl ester resins (e.g., resins used in filament winding and open and closed molding), polyurethanes, styrenic resins, acrylic resins, butadiene resins, and mixtures of any of the above.

A vinyl monomer may also be included as a diluent with the vinyl esters and the unsaturated and saturated resins. Suitable monomers may include those such as, for example, styrene and styrene derivatives such as alpha-methyl styrene, p-methyl styrene, divinyl benzene, divinyl toluene, ethyl styrene, vinyl toluene, tert-butyl styrene, monochloro styrene, dichloro styrene, vinyl benzyl chloride, fluorostyrene, and alkoxystyrenes (e.g., paramethoxy styrene). Other monomers which may be used include, for example, diallyl phthalate, hexyl acrylate, octyl acrylate, octyl methacrylate, diallyl itaconate, diallyl maleate, hydroxyethyl acrylate, hydroxyethyl methacrylate, hydroxypropyl acrylate and hydroxypropyl methacrylate. Mixtures of the above may also be employed.

Any suitable polyfunctional acrylate may be used in the resin composition, including those described, for example, in U.S. Pat. No. 4,916,023 to Kawabata et al., the disclosure of which is incorporated by reference herein in its entirety. Such compounds include ethylene glycol dimethacrylate, butanediol dimethacrylate, hexanediol dimethacrylate, ethoxylated trimethylol propane triacrylate, trimethylolpropane tri(meth)acrylate, trimethylolpropane triacrylate, trimethylolmethane tetramethacrylate, pentaerythritol tetramethacrylate, dipentaerythritol tetramethacrylate, dipentaerythritol pentamethacrylate, dipentaerythritol hexamethacrylate, ethoxylated polyhydric phenol diacrylates and dimethacrylates containing from 1 to 30 ethylene oxide units per OH group in the phenol, propoxylated polyhydric phenol diacrylates and dimethacrylates containing from 1 to 30 propylene oxide groups per OH groups in the phenol. Examples of some useful di- and polyhydric phenols include catechol; resorcinol; hydroquinone; 4,4′-biphenol; 4,4′-ispropylidenebis(o-cresol); 4,4′-isopropylidenebis(2-phenyl phenol); alkylidenediphenols such as bisphenol “A”; pyrogallol; phloroglucinol; naphthalene diols; phenol/formaldehyde resins; resorcinol/formaldehyde resins; and phenol/resorcinol/formaldehyde resins. Mixtures of the above di- and polyacrylates may also be employed.

Additives may also include inhibitors added to the resin mix to stop or delay any crosslinking chain reaction that might be started by the possible formation of free radicals. Because free radicals can be formed at the carbon-carbon double bonds through several different mechanisms, such as interactions between molecules with heat and light, the possibility of the formation of free radicals is quite high. Should this occur there is a good possibility that the resin could crosslink during storage. Therefore, the right amount of inhibitor in the system is necessary to minimize stability problems. Suitable inhibitor may include but are not limited to, hydroquinone (HQ), tolyl-hydroquinone (THQ), bisphenol “A” (BPA), naphthoquinone (NQ), p-benzoquinone (p-BQ), butylated hydroxy toluene (BHT), Hydroquinone monomethyl ether (HQMME), monotertiary butyl hydroquinone (MTBHQ), ditertiary Butyl hydroquinone (DTBHQ), tertiary butyl catechol (TBC). Other substituted and un-substituted phenols and mixtures of the above may be used.

Additional additives include phenolic type antioxidants as those described in pages 1 to 104 in “Plastic additives”, by R. Gächter and Müller, Hanser Publishers, 1990. Include also are Mannich type antioxidants, specially phenols and naphthols, suitable for the purpose herein include hindered aromatic alcohols, such as hindered phenols and naphthols, for example, those described in U.S. Pat. No. 4,324,717, the disclosure of which is incorporated herein by reference in its entirety.

Moisture scavenging agents are added for increasing the storage stability. In addition to the careful drying of all components, the addition of a drying agent (2 to 4%), like zeolite or molecular sieve, to the polyol component is recommended to bond possible residual moisture. Exemplary scavengers include Adsorption type—molecular sieves, generally zeolites with 3˜5 Angstrom pore size; Inorganic chemical scavenger—alkaline-earth oxides such as MgO and CaO; and Organic chemical scavenger—oxazolidine compounds and vinyl silanes

### EXAMPLES AND BRIEF DESCRIPTION OF DRAWINGS

To quantify the energy required to generate a first crack of the composite matrix (insipient damage), a method was developed utilizing an Instron Dynatup 9250 HV Impact drop tower. In this method, a load cell, or “tup,” is positioned between the striking point and a falling mass. The velocity of the falling striker is captured just prior to impact and the exact impact velocity and energy are then known. From this, the load/force is captured as a function of time during the event. From this data, calculations such as deflection of the specimen, velocity changes, and energy absorbed can now be extracted.

In the following examples, SMC specimens are tested on the 9250HV drop tower. In each case, a former art polyester or vinyl ester resin is compared to the new art hybrid system. Both samples are tested at the same conditions and specimen dimensions. Point “A” on the graph is a computer generated line that is placed tangent to the increasing load of the falling tup. Point “B” represents the load (in Lbs.) at which the samples sees insipient damage. Point “C” represents the absorbed energy (in ft lbf) at the point of insipient damage. Point “D” shows deviation from the tangent, or specimen deflection, with increasing load.

FIG. 1 is a graph showing load and energy build as a function of time. The SMC formulation is given in Example 1 and is a blend of two polyesters. From the graph, it is seen that the load is 297.0 lbs and the absorbed energy is 0.33 ft lbf when insipient damage occurs. It is also important to see that there is almost no deviation from the tangent to the load curve when damage occurs. This tells us that the sample behaves in a “brittle” fashion.

FIG. 2 is a graph showing load and energy build as a function of time. The SMC formulation is given in Example 2 and utilizes the resin composition of the invention blended with 25% unsaturated polyester. From this graph, it is seen that a load of 350.0 lbs and an absorbed energy of 0.60 ft lbf when insipient damage occurs. By looking at point “D” it can also be seen that there is a large area of deviation from the load tangent to the load curve when damage occurs. This is representative of the specimen deflecting, allowing increased absorbed energy before damage such as seen in a “ductile fracture.”

FIG. 3 is a graph showing load and energy build as a function of time. The SMC formulation is given in EXAMPLE 3 and is a blend of polyester and vinyl ester resins. From the graph, it can be determined that a load of 314.2 lbs and energy of 0.433 ft lbf is observed at the point of insipient damage. Much like FIG. 2, it can also be seen that the deviation from the load tangent is very slight, again representative of a “brittle” fracture.

FIG. 4 is a graph showing load and energy build as a function of time. The SMC formulation is given in EXAMPLE 4 and utilizes the resin composition of the invention. From the graph it can be seen that the new art hybrid at 100% concentration has a load of 728.9 lbs and an energy of 1.7318 ft lbf at the point of insipient damage. Most notable, however, is the large area of deviation from the load tangent. It is this area that shows us how the sample is able to deflect with the increasing load and absorb more of the impact energy before damage occurs much like a “ductile” specimen.

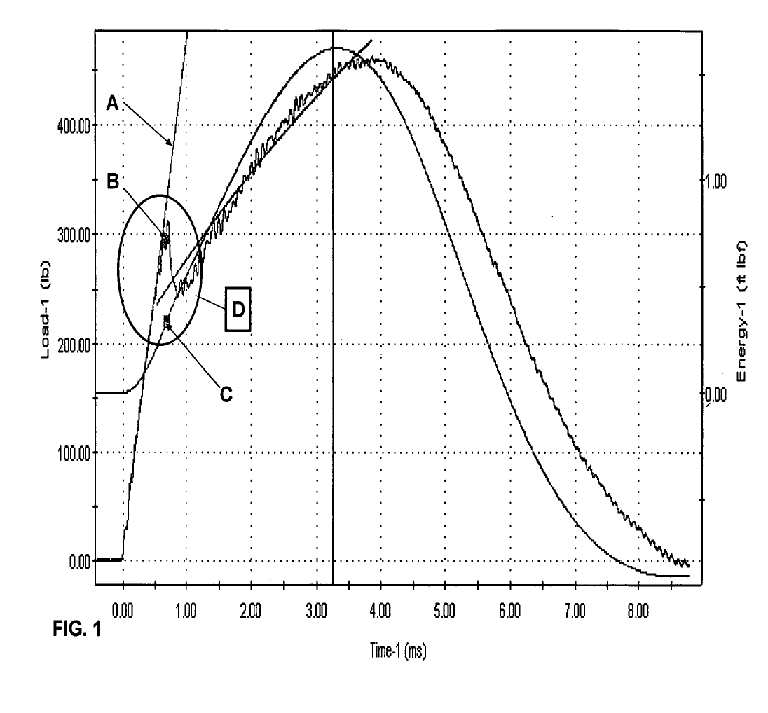

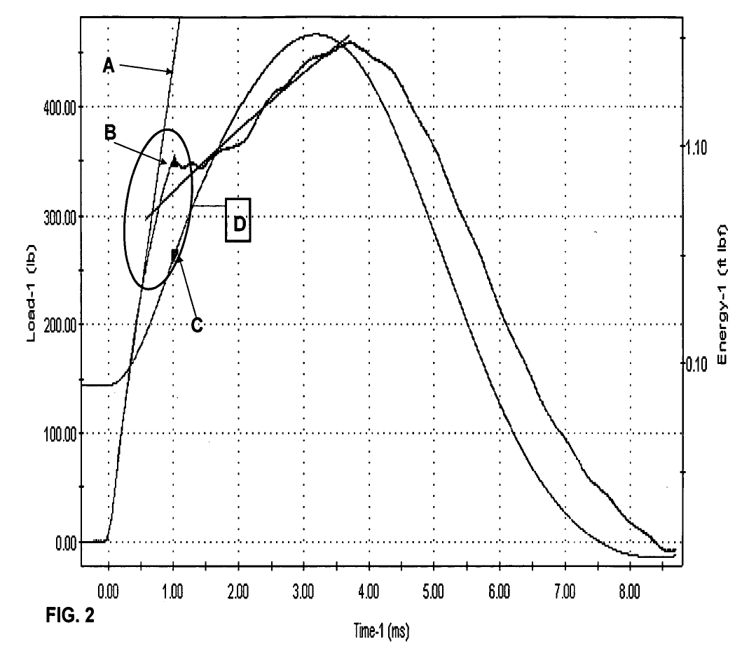

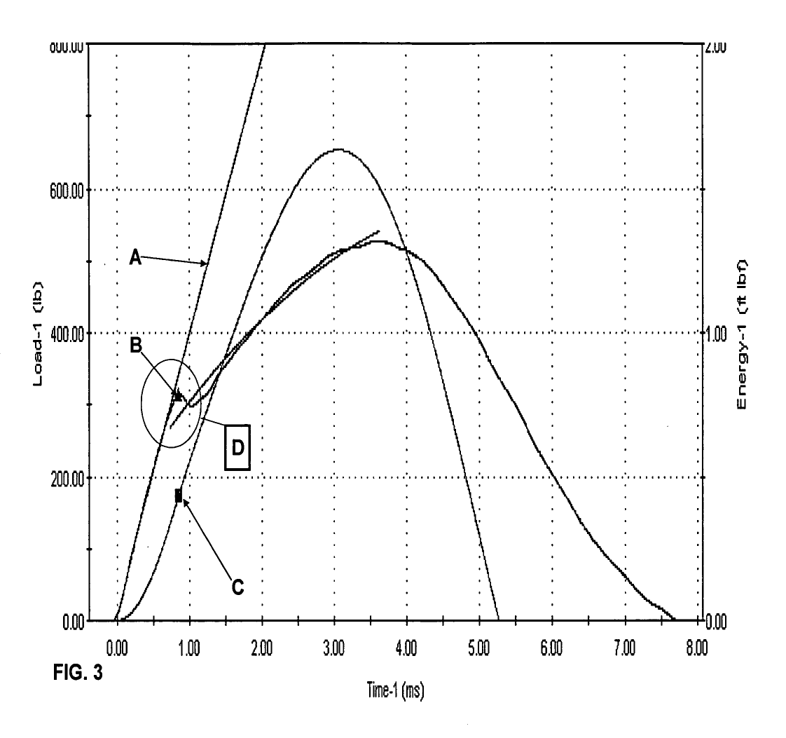

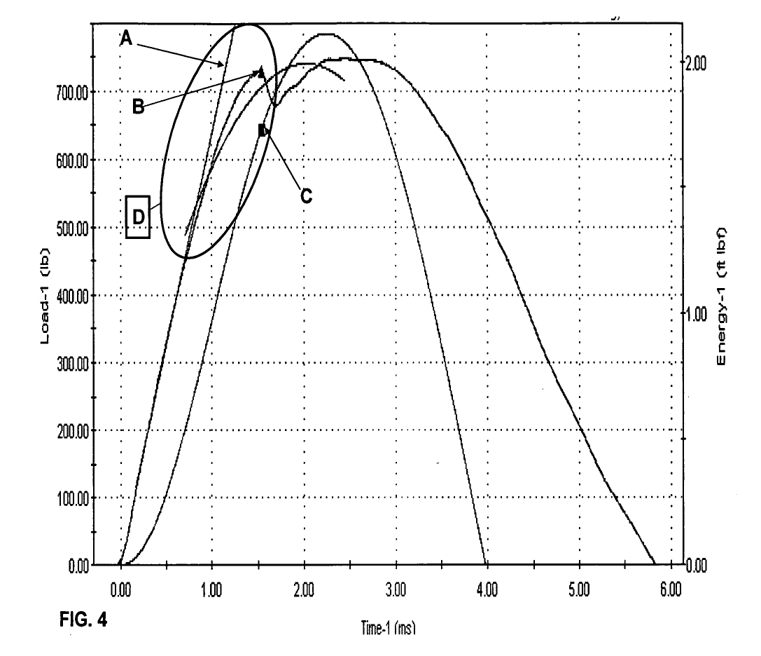

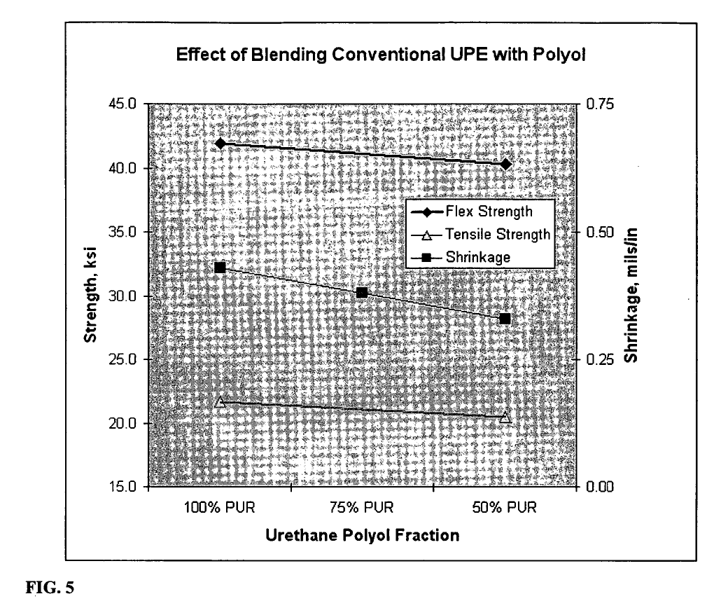

For the purpose of illustration, four compounds were produced and compared. Examples 1-7 represent the basic composition of each formulation, and FIG. 1-5 show impact properties associated with formulation.

Example 1 is an example of a general purpose SMC compound. Example 1 includes 27% fiber reinforcement. Polyester 1 in this formulation is a propylene glycol, maleic anhydride unsaturated polyester having a viscosity between 1,500-2,500 cps, and an Acid Value of 16.5-22.5. Polyester 2 is a 2-methyl-1,3-propanediol, phthalic acid unsaturated polyester having a viscosity between 1,400-1,700 cps. and an Acid Value of 13.5-17.5. LPA 1 is a polyvinyl acetate from Dow (LP 40A) and LPA 2 is a 35% solids solution of polymethyl methacrylate in styrene.

Example 2 is a general purpose SMC compound consisting of 27% fiber reinforcement. Polyester 1 is Reichhold's DION® 31616, which is a 2-methyl-1,3-propanediol, ethylene glycol, maleic anhydride unsaturated polyol having a viscosity between 300-500 cps. and an Acid Value of 0-4 mg/g of KOH/resin. Polyester 2 in this formulation is the same as Polyester 2 from Table 1. LPA 1 is Reichhold's 31701 polystyrene solution. LPA 2 is a solution of Kraton D1118 in styrene.

Example 3 is an example of a structural SMC compound consisting of 50% fiber reinforcement. Polyester 1 in this formulation is the same as Polyester 2 from Table 1 & 2. Vinyl Ester 1 is a thickenable vinyl ester resin from DOW (Derakane 786) with a viscosity between 500-1,200 cps. and an Acid Number between 26.0-34.0. LPA 1 is Reichhold's 31701 polystyrene solution. LPA 2 is a solution of Kraton D1118 in styrene. LPA 3 is a 35% solids solution of polymethyl methacrylate in styrene.

Examples 4-7 are examples of a structural SMC compound consisting of 50% fiber reinforcement. The unsaturated polyester polyol # 1 in this formulation is the same as 1 in Example 2. LPA 1 is Reichhold's 31701 polystyrene solution. LPA 2 is a solution of Kraton D1118 in styrene. The shrink control additive is a polyethylene powder sold under the name Microthene F—FN 51000.

The thickener used for Example 1 & 3 is a magnesium oxide solution (Plasicolors PG 9033).

The thickener used for Example 2 & 4-7 is Reichhold's Dion® 31100-00 which is a methylene diisocyanate prepolymer.

The inhibitor used in Example 1-7 is a 5% solution of parabenzoquinone.

Initiator 1 in Examples 1-7 is a t-butyl peroxybenzoate (Luperox TBPB)

Initiator 2 in Examples 1-7 is a peroxy ketal (Trigonox 29B75)

All impact and physical testing was completed on 14″×14″ plaques that were molded at a thickness of 0.100″.

Example 1

| | |
|---|---|
| Polyester 1 | 9.9% |
| Polyester 2 | 9.9% |
| LPA 1 | 8.1% |
| LPA 2 | 2.7% |
| Initiator 1 | 0.5% |
| Initiator 2 | 0.5% |
| Inhibitor 1 | 0.8% |
| Zinc Stearate | 0.5% |
| Calcium Carbonate | 64.1% |
| Thickener | 3.1% |
| Total | 100% |

Example 2

| | |
|---|---|
| Polyester 1 | 14.3% |
| Polyester 2 | 4.8% |
| LPA 1 | 5.7% |
| LPA 2 | 5.7% |
| Shrink Control Additive | 1.3% |
| Initiator 1 | 0.4% |
| Initiator 2 | 0.4% |
| Inhibitor 1 | 0.2% |
| Zinc Stearate | 0.9% |
| Calcium Carbonate | 61.8% |
| Thickener | 4.4% |
| Total | 100% |

Example 3

| | |
|---|---|
| Polyester 1 | 31.1% |
| Vinyl Ester 1 | 14.9% |
| LPA 1 | 7.9% |
| LPA 2 | 8.9% |
| LPA 3 | 6.0% |
| Initiator 1 | 0.3% |
| Initiator 2 | 0.3% |
| Inhibitor 1 | 0.6% |
| Zinc Stearate | 3.2% |
| Calcium Carbonate | 22.4% |
| Thickener | 1.2% |
| Pigment | 1.4% |
| Total | 100% |

Example 4

| | |
|---|---|
| Polyester 1 | 39.5% |
| LPA 1 | 7.4% |
| LPA 2 | 7.4% |
| Shrink Control Additive | 3.4% |
| Initiator 1 | 0.6% |
| Initiator 2 | 0.6% |
| Inhibitor 1 | 0.7% |
| Zinc Stearate | 2.1% |
| Calcium Carbonate | 24.0% |
| Thickener | 12.6% |
| Pigment | 1.4% |
| Total | 100% |

### Examples 5-7

| | 100% PUR | 75% PUR | 50% PUR |
|---|---|---|---|
| Ingredients | Example 5 | Example 6 | Example 7 |
| Polyester 1 | 40.1% | 30.9% | 21.2% |
| Polyester 2 | 0.0% | 10.3% | 21.2% |
| LPA 1 | 9.3% | 9.5% | 9.8% |
| LPA 2 | 9.3% | 9.5% | 9.8% |
| Shrink Control Additive | 3.1% | 3.2% | 3.3% |
| Compatibilizer | 0.2% | 0.3% | 0.3% |
| Initiator 1 | 0.5% | 0.6% | 0.6% |
| Initiator 2 | 0.5% | 0.6% | 0.6% |
| Inhibitor 1 | 0.6% | 0.6% | 0.6% |
| Zinc Stearate | 1.9% | 1.9% | 2.0% |
| Calcium Carbonate | 21.6% | 22.2% | 22.8% |
| Thickener | 11.7% | 9.2% | 6.8% |
| Pigment | 1.2% | 1.3% | 1.3% |
| TOTAL | 100.0% | 100.0% | 100.0% |
| Shrinkage, mil/in | | 0.38 | 0.33 |
| Flex Strength, ksi | 41.9 | | 40.3 |
| Tensile Strength, ksi | 21.7 | | 20.5 |

1. A molding composition comprising a urethane chain extended polyester formed by reacting in situ a low molecular weight unsaturated polyester polyol resin and a polyisocyanate intermediate free from ethylenic unsaturation and a low profile additive.

2. The molding composition of claim 1, wherein the low molecular weight polyester polyol has a molecular weight of about 500 to 10,000.

3. The molding composition of claim 1, wherein the polyisocyanate intermediate free from ethylenic unsaturation is selected form the group consisting of aromatic, aliphatic and cycloaliphatic polyisocyanates having two or more isocyanate groups per molecule.

4. The molding composition of claim 3, wherein the polyisocyanate intermediate free from ethylenic unsaturation has an isocyanate equivalent weight of less than 300.

5. The molding composition of claim 1, further including a high molecular weight block copolymer.

6. The molding composition of claim 5, wherein the high molecular weight block copolymer is a polystyrene/polyethylene oxide copolymer.

7. The molding composition of claim 1, further including the fiber reinforcement.

8. The molding composition of claim 1, further including a vinyl polymerization initiator.

9. The molding composition of claim 1, wherein the polyisocyanate intermediate free from ethylenic unsaturation is a polyfunctional additive prepared by reacting one equivalent weight of a diol or triol of molecular weight from 60 to 3,000 and an excess of a polyfunctional isocyanate.

10. The molding composition of claim 1, wherein the vinyl polymerization initiator is a peroxide or azonitrile initiator.

11. The molding composition of claim 1, further including an inhibitor.

12. The molding composition of claim 1 wherein the low molecular weight unsaturated polyester polyol resin is formed from a polyfunctional organic acid or anhydride and a polyhydric alcohol.

13. The molding composition of claim 12 wherein the polyhydric alcohol is selected form the group consisting of ethylene glycol, diethylene glycol, triethylene glycol, propylene glycol, dipropylene glycol, 1,3-butanediol, 1.4-butanediol, 1,3-hexanediol, neopentyl glycol, 2-methyl-1,3-pentanediol, 1,3-butylene glycol, 1,6-hexanediol, hydrogenated bisphenol “A”, cyclohexane dimethanol, 1,4-cyclohexanol, ethylene oxide adducts of bisphenols, propylene oxide adducts of bisphenols, sorbitol, 1,2,3,6-hexanetetrol, 1,4-sorbitan, pentaerythritol, dipentaerythritol, tripentaerythritol, 1,6-hexanediol di-pentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene.

14. The molding composition of claim 12 wherein the polyfunctional organic acid or anhydride is selected from the group consisting of maleic acid, fumaric acid, citraconic acid, itaconic acid, glutaconic acid, phthalic acid, isophthalic acid, terephthalic acid, tetrahydrophthalic anhydride, cyclohexane dicarboxylic acid, succinic anhydride, adipic acid, sebacic acid, azelaic acid, malonic acid and alkenyl succinic acids and anhydrides thereof.

15. The molding composition of claim 1 wherein the low molecular weight unsaturated polyol resin has an acid number of 0 to 20 mg KOH/g resin.

16. The molding composition of claim 1 wherein the low molecular weight unsaturated polyol resin has a hydroxyl value between 50 to 200 mg KOH/g resin.

17. The molding composition of claim 1, wherein the low molecular weight unsaturated polyol resin has a stoichiometric ratio of isocyanate to hydroxyl usage of from about 50 to 100 percent hydroxyl usage.

18. The molding composition of claim 1 comprising:
(a) 10 to 90 parts by weight of the total resin of the low molecular weight unsaturated polyester polyol resin and 1 to 30 parts by weight of the total resin of a polyisocyanate intermediate free from ethylenic unsaturation;
(b) 1 to 40 parts by weight of the total resin of low profile agent; and
(c) 0.1 to 10 parts by weight of a low molecular weight block copolymer.
